(19) United States
(12) Patent Application Publication
(10) Pub. No.: US 2025/0189788 A1
(43) Pub. Date: Jun. 12, 2025

(54) LAMINATE AND VIRTUAL REALITY DISPLAY DEVICE

(71) Applicant: FUJIFILM Corporation, Tokyo (JP)

(72) Inventors: Akira MARUYAMA, Minamiashigara-shi (JP); Ryoji GOTO, Minamiashigara-shi (JP); Aiko YAMAMOTO, Minamiashigara-shi (JP); Akihiro SUGITA, Minamiashigara-shi (JP)

(73) Assignee: FUJIFILM Corporation, Tokyo (JP)

(21) Appl. No.: 19/055,738

(22) Filed: Feb. 18, 2025

Related U.S. Application Data
(63) Continuation of application No. PCT/JP2023/033728, filed on Sep. 15, 2023.

(30) Foreign Application Priority Data
Sep. 29, 2022 (JP) 2022-156797

(51) Int. Cl. G02B 27/01; C08F 236/22

(52) U.S. Cl. CPC G02B 27/0101; C08F 236/22

(57) ABSTRACT

An object of the present invention is to provide a laminate including two cholesteric liquid crystal layers in which a reflectivity of the cholesteric liquid crystal layers formed by an application treatment is high. The laminate according to the present invention includes: a first cholesteric liquid crystal layer that is formed of a first composition including a first liquid crystal compound; and a second cholesteric liquid crystal layer that is formed on the first cholesteric liquid crystal layer by an application treatment using a second composition including a second liquid crystal compound, in which the first liquid crystal compound is a disk-like liquid crystal compound, the first liquid crystal compound is a compound different from the second liquid crystal compound, among bright lines and dark lines that are derived from a cholesteric liquid crystalline phase, in a case where a dark line at a farthest position from the first cholesteric liquid crystal layer side is represented by a surface layer dark line and a dark line at a closest position to an intermediate position in a thickness direction of the second cholesteric liquid crystal layer is represented by an intermediate dark line, a ratio of a region width where the surface layer dark line is present to a width of the intermediate dark line is 1.2 or less.

### CROSS-REFERENCE TO RELATED APPLICATIONS

This application is a Continuation of PCT International Application No. PCT/JP2023/033728 filed on Sep. 15, 2023, which claims priority under 35 U.S.C. § 119(a) to Japanese Patent Application No. 2022-156797 filed on Sep. 29, 2022. The above applications are hereby expressly incorporated by reference, in their entirety, into the present application.

### BACKGROUND OF THE INVENTION

### 1. Field of the Invention

The present invention relates to a laminate and a virtual reality display device including the laminate.

### 2. Description of the Related Art

A laminate including two or more layers that are formed of compositions including liquid crystal compounds is used for various uses. The above-described laminate is likely to be used for optical use due to optical characteristics derived from the liquid crystal compounds in the laminate.

For example, JP2014-142618A discloses an optical film (laminate) including: a first optically-anisotropic layer; and a second optically-anisotropic layer that is provided on a surface of the first optically-anisotropic layer, in which the first optically-anisotropic layer is a layer where a liquid crystal compound is aligned and polymerized to be immobilized, and a surface tilt angle of the liquid crystal compound on a side in contact with the second optically-anisotropic layer is in a range of 5° to 80°.

On the other hand, in the above-described laminate, an aspect (cholesteric liquid crystal layer) including a layer where an alignment direction of a cholesteric liquid crystal compound is immobilized.

### SUMMARY OF THE INVENTION

A laminate including two or more cholesteric liquid crystal layers may be used as an element using characteristics of the cholesteric liquid crystal layer.

In this case, a reflectivity of electromagnetic waves in a specific wavelength range (hereinafter, also simply referred to as “reflectivity”) is required to be high.

In addition, from the viewpoint that manufacturing steps can be reduced, it is preferable that the above-described laminate including two or more cholesteric liquid crystal layers is manufactured by sequentially applying compositions including liquid crystal compounds. That is, it is preferable that one cholesteric liquid crystal layer is formed of a composition including a liquid crystal compound, and a composition including a liquid crystal compound is applied to the formed one cholesteric liquid crystal layer to form another cholesteric liquid crystal layer.

The present inventors manufactured a laminate including two cholesteric liquid crystal layers by sequentially applying compositions including a liquid crystal compound with reference to the method described in JP2014-142618A, and found that a reflectivity of the obtained laminate does not satisfy the recently required level and improvement is required.

Accordingly, an object of the present invention is to provide a laminate including two cholesteric liquid crystal layers in which a reflectivity of the cholesteric liquid crystal layers formed by an application treatment is high.

In addition, another object of the present invention is to provide a virtual reality display device including the laminate.

The present inventors conducted a thorough investigation to achieve the objects, thereby completing the present invention. That is, the present inventors have found that the objects are achieved by the following configuration.

[1] A laminate comprising:
a first cholesteric liquid crystal layer that is formed of a first composition including a first liquid crystal compound; and
a second cholesteric liquid crystal layer that is formed on the first cholesteric liquid crystal layer by an application treatment using a second composition including a second liquid crystal compound,
in which the first liquid crystal compound is a disk-like liquid crystal compound, the first liquid crystal compound is a compound different from the second liquid crystal compound,
among bright lines and dark lines that are observed in observation of a cross section of the second cholesteric liquid crystal layer with a scanning electron microscope and are derived from a cholesteric liquid crystalline phase of the second cholesteric liquid crystal layer, in a case where a dark line at a farthest position from the first cholesteric liquid crystal layer side is represented by a surface layer dark line and a dark line at a closest position to an intermediate position in a thickness direction of the second cholesteric liquid crystal layer is represented by an intermediate dark line,
a ratio of a region width where the surface layer dark line is present in the thickness direction of the second cholesteric liquid crystal layer to a width of the intermediate dark line in the thickness direction of the second cholesteric liquid crystal layer is 1.2 or less.

[2] The laminate according to [1],
in which a ratio of a region width where the intermediate dark line is present in the thickness direction of the second cholesteric liquid crystal layer to the width of the intermediate dark line in the thickness direction of the second cholesteric liquid crystal layer is 3.0 or less.

[3] A laminate comprising:
a first cholesteric liquid crystal layer that is formed of a first composition including a first liquid crystal compound; and
a second cholesteric liquid crystal layer that is formed on the first cholesteric liquid crystal layer by an application treatment using a second composition including a second liquid crystal compound,
in which the first liquid crystal compound is a disk-like liquid crystal compound,
the first liquid crystal compound is different from the second liquid crystal compound,
the second cholesteric liquid crystal layer includes a surfactant, and
the number of aggregates of the surfactant having a major axis diameter of 0.5 μm or more in a surface of the second cholesteric liquid crystal layer opposite to the first cholesteric liquid crystal layer side is less than 10000 aggregates/mm².

[4] The laminate according to [3],
in which the surfactant includes a first surfactant and a second surfactant.

[5] The laminate according to [4],
in which the first surfactant is a surfactant in the first composition, and
the first surfactant is liquid-crystalline and has a phase transition temperature of 100° C. or higher from a liquid crystal phase to an isotropic liquid phase, or
the first surfactant is non-liquid-crystalline and has a melting point of 90° C. or higher.

[6] The laminate according to [4] or [5],
in which the first surfactant has four or more aromatic ring structures.

[7] The laminate according to any one of [4] to [6],
in which a molecular weight of the first surfactant is 5000 or lower.

[8] The laminate according to any one of [4] to [7], in which the first surfactant is represented by Formula (11).

[9] The laminate according to any one of [3] to [8], in which the second liquid crystal compound is a rod-like liquid crystal compound.

[10] A virtual reality display device comprising:
the laminate according to any one of [1] to [9].

According to the present invention, it is possible to provide a laminate including two cholesteric liquid crystal layers in which a reflectivity of the cholesteric liquid crystal layers formed by an application treatment is high.

In addition, according to the present invention, it is also possible to provide a virtual reality display device including the laminate.

### BRIEF DESCRIPTION OF THE DRAWINGS

FIG. 1 is a diagram showing an example of a laminate according to the present invention.

FIG. 2 is a schematic enlarged cross sectional view showing the vicinity of a surface of a second cholesteric liquid crystal layer A12 opposite to a first cholesteric liquid crystal layer A10 side in the laminate shown in FIG. 1, the cross sectional view being obtained with a scanning electron microscope.

### DESCRIPTION OF THE PREFERRED EMBODIMENTS

Hereinafter, the details of the present invention will be described.

The constituent requirements described below may be embodied based on the representative embodiments of the present invention. However, the present invention is not limited to such embodiments.

Hereinafter, the same meanings are used in the present specification.

In the present specification, numerical ranges represented by “to” include numerical values before and after “to” as lower limit values and upper limit values.

In the present specification, a case where a first liquid crystal compound and a second liquid crystal compound are different from each other includes an aspect where the first liquid crystal compound is a disk-like liquid crystal compound and the second liquid crystal compound is a rod-like liquid crystal compound and an aspect where the first liquid crystal compound is a disk-like liquid crystal compound and the second liquid crystal compound is a first liquid crystal compound.

### [First Embodiment of Laminate]

A first embodiment of a laminate according to the present invention is a laminate including: a first cholesteric liquid crystal layer A that is formed of a first composition A including a first liquid crystal compound A; and a second cholesteric liquid crystal layer A that is formed on the first cholesteric liquid crystal layer A by an application treatment using a second composition A including a second liquid crystal compound A. Here, the first liquid crystal compound A in the first composition A is a disk-like liquid crystal compound, and the first liquid crystal compound A in the first composition A and the second liquid crystal compound A in the second composition A are different from each other.

In addition, among bright lines and dark lines that are observed in observation of a cross section of the second cholesteric liquid crystal layer A with a scanning electron microscope and are derived from a cholesteric liquid crystalline phase of the second cholesteric liquid crystal layer A, in a case where a dark line at a farthest position from the first cholesteric liquid crystal layer A side is represented by a surface layer dark line and a dark line at a closest position to an intermediate position in a thickness direction of the second cholesteric liquid crystal layer A is represented by an intermediate dark line, a ratio of a region width where the surface layer dark line is present in the thickness direction of the second cholesteric liquid crystal layer A to a width of the intermediate dark line in the thickness direction of the second cholesteric liquid crystal layer A is 1.2 or less.

The cholesteric liquid crystal layer refers to a layer obtained by immobilizing a cholesterically aligned liquid crystal compound.

The first embodiment of the laminate will be described with reference to the drawings.

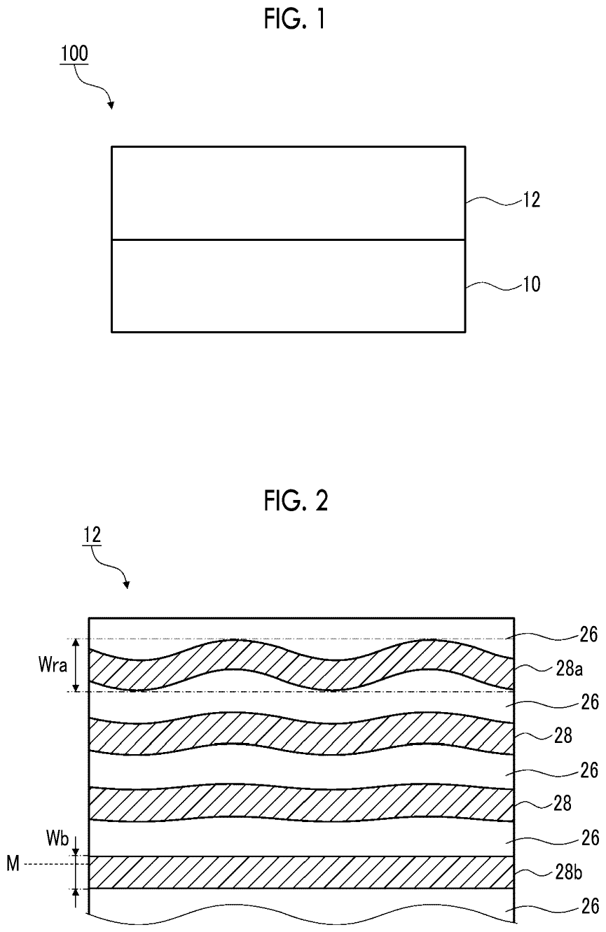

As shown in FIG. 1, a laminate 100 includes the first cholesteric liquid crystal layer A10 and the second cholesteric liquid crystal layer A12. The first cholesteric liquid crystal layer A10 is formed of the first composition A including the first liquid crystal compound A. In addition, the second cholesteric liquid crystal layer A12 is formed on the first cholesteric liquid crystal layer A10 by the application treatment using the second composition A including the second liquid crystal compound A.

In general, in a case where a cross section of the cholesteric liquid crystal layer is observed with a scanning electron microscope, a stripe pattern where bright lines and dark lines derived from a cholesteric liquid crystalline phase are alternately laminated in the thickness direction is observed. In the first cholesteric liquid crystal layer A10 and the second cholesteric liquid crystal layer A12 of FIG. 1, the above-described stripe pattern is observed in observation of a cross section with a scanning electron microscope.

FIG. 2 is a schematic enlarged cross sectional view showing the vicinity of a surface of the second cholesteric liquid crystal layer A12 opposite to the first cholesteric liquid crystal layer A10 side, the cross sectional view being obtained with a scanning electron microscope. Using FIG. 2, the width of the intermediate dark line and the region width where the surface layer dark line is present will be described.

In the second cholesteric liquid crystal layer A12, bright lines 26 and dark lines 28 derived from the cholesteric liquid crystalline phase are observed in a state where they are alternately present in the thickness direction of the second cholesteric liquid crystal layer A12. The intermediate position in the thickness direction of the second cholesteric liquid crystal layer A12 is shown as an intermediate position M in FIG. 2.

Here, the dark line 28 at the closest position to the intermediate position M will be referred to as an intermediate dark line 28b, and the dark line 28 at the farthest position from the first cholesteric liquid crystal layer A10 side will be referred to as a surface layer dark line 28a. In FIG. 2, the surface layer dark line 28a is disposed in a wave-like shape having an amplitude in the thickness direction of the second cholesteric liquid crystal layer A12.

The second cholesteric liquid crystal layer A12 is a layer formed by the application treatment. In general, in a case where a cholesteric liquid crystal layer is formed by an application treatment, there are many cases where controlled alignment of liquid crystal compounds on an air interface side cannot be sufficient. Therefore, bright lines and dark lines derived from a cholesteric liquid crystalline phase on the air interface side are likely to have a wave-like shape. On the other hand, in a case where a cholesteric liquid crystal layer is formed by an application treatment, liquid crystal compounds are likely to be aligned at an intermediate position in a thickness direction of the cholesteric liquid crystal layer, and thus linear bright lines and dark lines are likely to be formed.

As shown in FIG. 2, a width Wb corresponds to the width of the intermediate dark line 28b.

In addition, as shown in FIG. 2, a region width Wra corresponds to the width of the region where the surface layer dark line 28a is present in the thickness direction of the second cholesteric liquid crystal layer A12. The region width Wra corresponds to a length in which the wave-like surface layer dark line 28a is projected in the thickness direction in the cross sectional view observed with a scanning electron microscope.

In the present embodiment, a ratio (Wra/Wb) of the region width Wra to the width Wb is 1.2 or less, preferably 1.1 or less, and more preferably 1.05 or less. The lower limit is not particularly limited and is, for example, 1.0 or more.

The value of the ratio (Wra/Wb) being close to 1.0 represents that the surface layer dark line is linearly present without being present to be spread in the thickness direction of the second cholesteric liquid crystal layer A (for example, in a wave-like state). The above-described state is considered to reflect that the alignment of the second liquid crystal compound A in the second cholesteric liquid crystal layer A is not disordered. Although the mechanism is not necessarily clear, when the above-described state is achieved, it is considered that reflection from the second liquid crystal compound A in an unintended direction is suppressed, and the reflectivity of the cholesteric liquid crystal layer is not high.

Hereinafter, a specific method of obtaining the region width Wra and the width Wb will be described.

The observation of the cross section for obtaining the region width Wra and the width Wb is performed in the following procedure.

First, the laminate including the first cholesteric liquid crystal layer A and the second cholesteric liquid crystal layer A is embedded with an epoxy resin. The embedded laminate is cut with an ultramicrotome to obtain a sample for observation where a cross section of the laminate appears. In a case where the sample for observation is obtained, the laminate is cut in a direction perpendicular to the surface of the laminate. The cutting with the ultramicrotome is performed such that the thickness of the cut test piece is 200 nm.

Carbon is vapor-deposited on a surface of the obtained sample for observation in order to ensure the conductivity of the surface.

Next, the test piece for observation is observed with a scanning electron microscope (SEM). As the SEM, for example, “S-4800” (manufactured by Hitachi High-Tech Corporation) can be used. In the observation with the SEM, an acceleration voltage is set to 2 kV, and a secondary electron image is acquired at a magnification of 20000-fold. The acceleration voltage and the magnification may be appropriately changed depending on observation targets.

In this case, the secondary electron image (observed image) is typically a gray scale image where the bit depth of one pixel is 8 (0 to 255). As the value of each pixel increases, the image approaches white, and as the value of each pixel decreases, the image approaches black.

In the observation procedure, an image (observed image) where only the bright lines and the dark lines derived from the cholesteric liquid crystalline phase of the second cholesteric liquid crystal layer A are seen can be acquired.

The observed image obtained in the above-described procedure is analyzed in the following procedure to obtain the region width Wra and the width Wb.

First, an average brightness value that is an average value of the brightness of the brightest pixel and the brightness of the darkest pixel among the pixels of the region of the observed image corresponding to the second cholesteric liquid crystal layer A is acquired, and the average brightness is a threshold value.

In addition, in the observed image, thicknesses of the second cholesteric liquid crystal layer A are measured to obtain an average thickness of the second cholesteric liquid crystal layer A. The average thickness is obtained by measuring the thickness of the second cholesteric liquid crystal layer A at five positions to obtain an arithmetic average value thereof.

Next, by processing the observed image such that, among the pixels, a pixel that is darker (the value is smaller) than the above-described threshold value is set to 0 (black) and a pixel that is brighter (the value is larger) than the above-described threshold value is set to 1 (white), and thus a processed observed image is obtained. In the processed observed image, the region of the bright line is white, and the region of the dark line is black.

In the processed observed image, an average width of the dark line (in FIG. 2, the intermediate dark line 28b) at the closest position to the intermediate position in the thickness direction of the second cholesteric liquid crystal layer A is obtained as the width Wb. The average width of the dark line is obtained by measuring the width of the dark line at five positions in the thickness direction of the second cholesteric liquid crystal layer A to obtain an arithmetic average value thereof.

In addition, in the processed observed image, the region width where the dark line (in FIG. 2, the surface layer dark line 28a) at the farthest position from the first cholesteric liquid crystal layer A side in the thickness direction of the second cholesteric liquid crystal layer A is present is obtained as the region width Wra. The region width is obtained by measuring the width in the thickness direction of the second cholesteric liquid crystal layer A from the position where the dark line closest to the first cholesteric liquid crystal layer A side is present to the position where the dark line far from the first cholesteric liquid crystal layer A side is present.

Using the above-described method, the region width Wra and the width Wb are obtained.

In the processed observed image, in the vicinity of the surface of the second cholesteric liquid crystal layer A opposite to the first cholesteric liquid crystal layer A side, a discontinuous black region may be observed but is not considered a dark line. The above-described dark line refers to a portion of a black region that is continuously present in a direction orthogonal to the thickness direction of the second cholesteric liquid crystal layer A in the processed observed image.

As in the procedure of obtaining the region width Wra, a width of a region (hereinafter also referred to as “region width Wrb”) where the dark line (in FIG. 2, the intermediate dark line 28b) at the closest position to the intermediate position in the thickness direction of the second cholesteric liquid crystal layer A is present is also obtained.

Here, the value of a ratio (region width Wrb/width Wb) of the region width Wrb to the width Wb is preferably 3.0 or less, more preferably 1.2 or less, and still more preferably 1.1 or less. The lower limit of the value of the ratio of the region width Wrb to the width Wb is, for example, 1.0.

The value of the ratio of the region width Wrb to the width Wb being close to 1.0 represents that the dark line at the closest position to the intermediate position in the thickness direction of the second cholesteric liquid crystal layer A is linearly present without being present to be spread in the thickness direction of the second cholesteric liquid crystal layer A (for example, in a wave-like state). When the value of the ratio of the region width Wrb to the width Wb is in the above-described preferable range, the reflectivity of the cholesteric liquid crystal layer is likely to increase.

Hereinafter, each of the configurations of the first embodiment of the laminate and a material used in each of the configurations will be described.

### <First Cholesteric Liquid Crystal Layer A>

The first embodiment of the laminate according to the present invention includes the first cholesteric liquid crystal layer A that is formed of the first composition A including the first liquid crystal compound A. That is, the first cholesteric liquid crystal layer A is a layer obtained by immobilizing the cholesterically aligned first liquid crystal compound A. Accordingly, the first cholesteric liquid crystal layer A may include a component derived from a component in the first composition A described below.

The layer obtained by immobilizing the cholesterically aligned first liquid crystal compound A may be a layer that is changed to a state in which the alignment is not changed by an external field, an external force, or the like. In the first cholesteric liquid crystal layer A, optical characteristics of the cholesteric liquid crystalline phase only need to be maintained in the layer, and the first liquid crystal compound A in the first cholesteric liquid crystal layer A does not need to be liquid-crystalline any more. For example, the molecular weight of the first liquid crystal compound A may increase due to a curing reaction such that the liquid crystallinity thereof is lost.

The first cholesteric liquid crystal layer A can reflect electromagnetic waves (light) in a specific wavelength range using the cholesterically aligned first liquid crystal compound A. A central wavelength λ of light to be reflected from the first cholesteric liquid crystal layer A depends on a pitch P of a helical structure (=the period of the helix) in the cholesteric liquid crystalline phase, and is expressed by a relationship of λ=n×P with an average refractive index n of the first cholesteric liquid crystal layer A. The central wavelength of light to be reflected from the first cholesteric liquid crystal layer A can be obtained as follows. In a case where a transmission spectrum of the reflective layer A is measured from a normal direction of the first cholesteric liquid crystal layer A using a spectrophotometer UV3150 (manufactured by Shimadzu Corporation), a spectrum having a peak at which a transmittance decreases in a range near the central wavelength λ is obtained. Among two wavelengths having a transmittance that is ½ of the maximum peak value, in a case where a value of a wavelength on a shorter wavelength side is represented by λₗ (nm) and a value of a wavelength on a longer wavelength side is denoted by λₕ (nm), the central wavelength λ of the reflected light is obtained from the following expression.

$$λ = ( {λ}_{1} + {λ}_{h} ) / 2$$

The central wavelength λ of light to be reflected from the first cholesteric liquid crystal layer A is not particularly limited and is preferably in a visible range (wavelength 400 to 700 nm).

The reflectivity of the first cholesteric liquid crystal layer A at the central wavelength λ is preferably 40% or more, more preferably 45% or more, still more preferably 47% or more, and still more preferably 49% or more. The upper limit of the reflectivity is, for example, 50% or less.

The pitch of the cholesteric liquid crystalline phase changes depending on the kind of a chiral agent used together with the first liquid crystal compound A and an addition concentration thereof, and a cholesteric liquid crystalline phase having a desired pitch can be obtained by adjusting one or more of the kind or the addition concentration. Regarding a helical turning direction and a method of measuring the pitch, it is possible to use the method described on page 46 of “Liquid Crystal Chemical Experiment Introduction” edited by Japan Liquid Crystal Society, published by Sigma Corporation in 2007, and page 196 of “Liquid Crystal Handbook” Liquid Crystal Handbook Editing Committee, Maruzen Publishing Co., Ltd.

In a case where the first composition A including a surfactant is used during the formation of the first cholesteric liquid crystal layer A, a large amount of the surfactant is likely to be included in the vicinity of the interface between the first cholesteric liquid crystal layer A and the second cholesteric liquid crystal layer A. Examples of a method of verifying a distribution of the surfactant include a method of analyzing a secondary ion intensity derived from the surfactant in a depth direction by time-of-flight secondary ion mass spectrometry (TOF-SIMS) while performing ion sputtering. The TOF-SIMS is specifically described in “Surface Analysis Technology Library Secondary Ion Mass Spectrometry” edited by the Surface Science Society of Japan and published by Maruzen Co., Ltd. (1999). In a case where the components of the laminate in the depth direction are analyzed by TOF-SIMS while irradiating the optically-anisotropic layer with the ion beam to the optically anisotropic layer, a series of operations are repeated, the operations including: performing the component analysis in a surface depth region of 1 to 2 nm; further digging through the optically anisotropic layer with the ion beam in the depth direction by 1 nm to several hundreds of nm; and performing the component analysis in the next surface depth region of 1 to 2 nm.

The thickness of the first cholesteric liquid crystal layer A is preferably 0.1 to 10 μm and more preferably 0.3 to 5 μm.

Hereinafter, the first composition A used for forming the first cholesteric liquid crystal layer A will be described.

### <First Composition A>

The first composition A used for forming the first cholesteric liquid crystal layer A includes the first liquid crystal compound A.

Hereinafter, the components in the first composition A and component that may be included in the first composition A will be described.

### (First Liquid Crystal Compound A)

The first liquid crystal compound A is not particularly limited as long as it is a disk-like liquid crystal compound, and a well-known disk-like liquid crystal compound can be used. Note that, as the first liquid crystal compound A, a compound different from the second liquid crystal compound A described below is selected.

Examples of a method of cholesterically aligning the first liquid crystal compound A include a method of using the first composition A including the first liquid crystal compound A and a chiral agent.

The first liquid crystal compound A may be a polymerizable liquid crystal compound having a polymerizable group. The first liquid crystal compound A is preferably a disk-like liquid crystal compound.

As the polymerizable disk-like liquid crystal compound, for example, compounds described in paragraphs “0020” to “0067” of JP2007-108732A and “0013” to “0108” of JP2010-244038A can be preferably used.

The first liquid crystal compound A may be used alone or in combination of two or more kinds thereof.

The content of the first liquid crystal compound A in the first composition A is not particularly limited, and is preferably 50% by mass or more and more preferably 70% by mass or more with respect to the total solid content in the first composition A. The upper limit is not particularly limited and is 90% by mass or less in many cases.

Note that the solid content refers to a component capable of forming the first cholesteric liquid crystal layer A from which a solvent is removed, and even in a case where the component is liquid, the component is considered as the solid content.

### (First Surfactant A1)

The first composition A may include a first surfactant A1. The first surfactant A1 is preferably a component that is likely to be condensed on the air interface side of the coating film and can control the alignment of the first liquid crystal compound A during application of the first composition A.

In the first embodiment, the first surfactant A1 is not particularly limited, but a first surfactant B1 used in a second embodiment described below is also preferably used in a preferable aspect. It is also preferable that preferable characteristics and the like of the first surfactant A1 are the same as those of the first surfactant B1.

By using the first surfactant B1 used in the second embodiment described below, the dark line region width/dark line width ratio is likely to be adjusted to be in the above-described range.

The content of the first surfactant A1 with respect to the total solid content of the first composition A is preferably 0.01% to 1% by mass and more preferably 0.05% to 0.5% by mass.

### (Solvent)

The first composition A may include a solvent.

The solvent is not particularly limited as long as the components in the first composition A are soluble therein. Examples of the organic solvent include an ester-based solvent, an ether-based solvent, an amide-based solvent, a carbonate-based solvent, a ketone-based solvent, an aliphatic hydrocarbon-based solvent, an alicyclic hydrocarbon-based solvent, an aromatic hydrocarbon-based solvent, a halogenated carbon-based solvent, water, and an alcohol-based solvent.

The solvent may be used alone or as a mixture of two or more kinds.

### (Other Components)

The first composition A may include components other than the above-described components.

For example, the first composition A may include a polymerization initiator. In a case where the first composition A includes the polymerization initiator, the polymerization of the polymerizable liquid crystal compound progresses more efficiently.

The polymerization initiator may be, for example, a well-known polymerization initiator, examples of which include a photopolymerization initiator and a thermal polymerization initiator, among which a photopolymerization initiator is preferable.

The content of the polymerization initiator in the first composition A is not particularly limited, and is preferably 0.01% to 20% by mass and more preferably 0.5% to 10% by mass with respect to the total solid content in the first composition A.

In addition, the first composition A may include a chiral agent as the other components.

By the first composition A including the chiral agent, the first liquid crystal compound A can be twisted and aligned along the helical axis.

The kind of the chiral agent is not particularly limited. Any of well-known chiral agents (for example, the chiral agents described in “Liquid Crystal Device Handbook” edited by the 142nd Committee of the Japan Society for the Promotion of Science, Chapter 3, 4-3, Chiral agents for TN and STN, p. 199, 1989) can be used.

The chiral agent may be a photosensitive chiral agent where the helical twisting power changes due to light irradiation (hereinafter, also simply referred to as “chiral agent A”). The chiral agent A may be liquid-crystalline or non-liquid-crystalline. In general, the chiral agent A is likely to include a chiral carbon atom. The chiral agent A may be an axially chiral compound or a planar chiral compound that does not include a chiral carbon atom.

The chiral agent A may include a polymerizable group.

The first composition A may include two or more kinds of the chiral agents A, and may include at least one chiral agent A and at least one chiral agent where the helical twisting power does not change due to light irradiation.

The content of the chiral agent A in the first composition A is not particularly limited, and from the viewpoint that the first liquid crystal compound A is likely to be uniformly aligned, is preferably 5.0% by mass or less, more preferably 3.0% by mass or less, and still more preferably 2.0% by mass or less with respect to the total mass of the first liquid crystal compound A. The lower limit of the content of the chiral agent A is not particularly limited and is preferably 0.01% by mass or more, more preferably 0.02% by mass or more, and still more preferably 0.05% by mass or more with respect to the total mass of the first liquid crystal compound A.

### <Second Cholesteric Liquid Crystal Layer A>

The first embodiment of the laminate according to the present invention includes the second cholesteric liquid crystal layer A that is formed on the first cholesteric liquid crystal layer A by the application treatment using the second composition A including the second liquid crystal compound A. That is, the second cholesteric liquid crystal layer A is a layer obtained by immobilizing the cholesterically aligned second liquid crystal compound A. Accordingly, the second cholesteric liquid crystal layer A may include a component derived from a component in the second composition A described below.

The layer obtained by immobilizing the cholesterically aligned second liquid crystal compound A may be a layer that is changed to a state in which the alignment is not changed by an external field, an external force, or the like. In the second cholesteric liquid crystal layer A, optical characteristics of the cholesteric liquid crystalline phase only need to be maintained in the layer, and the second liquid crystal compound A in the second cholesteric liquid crystal layer A does not need to be liquid-crystalline any more. For example, the molecular weight of the second liquid crystal compound A may increase due to a curing reaction such that the liquid crystallinity thereof is lost.

The second cholesteric liquid crystal layer A can reflect electromagnetic waves (light) in a specific wavelength range using the cholesterically aligned second liquid crystal compound A. A central wavelength λ of light to be reflected from the second cholesteric liquid crystal layer A depends on a pitch P of a helical structure (=the period of the helix) in the cholesteric liquid crystalline phase, and is expressed by a relationship of λ=n×P with an average refractive index n of the second cholesteric liquid crystal layer A. The central wavelength of light to be reflected from the second cholesteric liquid crystal layer A can be obtained as in the central wavelength of light to be reflected from the first cholesteric liquid crystal layer A.

The central wavelength λ of light to be reflected from the second cholesteric liquid crystal layer A is not particularly limited and is preferably in a visible range.

The reflectivity of the second cholesteric liquid crystal layer A at the central wavelength λ is preferably 40% or more, more preferably 45% or more, still more preferably 47% or more, and still more preferably 49% or more. The upper limit of the reflectivity is, for example, 50% or less.

The pitch of the cholesteric liquid crystalline phase changes depending on the kind of a chiral agent used together with the second liquid crystal compound A and an addition concentration thereof, and a cholesteric liquid crystalline phase having a desired pitch can be obtained by adjusting one or more of the kind or the addition concentration.

The second cholesteric liquid crystal layer A may include the components in the first composition A used for forming the first cholesteric liquid crystal layer A. For example, the second cholesteric liquid crystal layer A may also include the first surfactant.

In a case where the second composition A including a surfactant is used during the formation of the second cholesteric liquid crystal layer A, a large amount of the surfactant is likely to be included in the surface of the second cholesteric liquid crystal layer A opposite to the first cholesteric liquid crystal layer A side. The distribution of the surfactant in the second cholesteric liquid crystal layer A can be verified using the same method as the method described regarding the first cholesteric liquid crystal layer A.

The thickness of the second cholesteric liquid crystal layer A is preferably 0.1 to 10 μm and more preferably 0.3 to 5 μm.

Hereinafter, the second composition A used for forming the second cholesteric liquid crystal layer A will be described.

### <Second Composition A>

The second composition A used for forming the second cholesteric liquid crystal layer A includes the second liquid crystal compound A.

Hereinafter, the components in the second composition A and component that may be included in the second composition A will be described.

### (Second Liquid Crystal Compound A)

The second liquid crystal compound A is not particularly limited, and a well-known liquid crystal compound can be used. Note that, as the second liquid crystal compound A, a compound different from the first liquid crystal compound A is selected. Examples of the liquid crystal compound include a rod-like liquid crystal compound and a disk-like liquid crystal compound. Examples of a method of cholesterically aligning the second liquid crystal compound A include a method of using the second composition A including the second liquid crystal compound A and a chiral agent.

The second liquid crystal compound A may be a polymerizable liquid crystal compound having a polymerizable group.

As the second liquid crystal compound A, a polymerizable rod-like liquid crystal compound or a polymerizable disk-like liquid crystal compound is preferable, and a polymerizable rod-like liquid crystal compound is more preferable from the viewpoint of reducing a thickness-direction retardation of the laminate.

For example, as the polymerizable rod-like liquid crystal compound, compounds described in claim 1 of JP1999-513019A (JP-H11-513019A) and paragraphs [0026] to [0098] of JP2005-289980A can be preferably used.

As the polymerizable disk-like liquid crystal compound, for example, compounds described in paragraphs “0020” to “0067” of JP2007-108732A and “0013” to “0108” of JP2010-244038A can be preferably used.

The second liquid crystal compound A may be used alone or in combination of two or more kinds thereof.

The content of the second liquid crystal compound A in the second composition A is not particularly limited, and is preferably 50% by mass or more and more preferably 70% by mass or more with respect to the total solid content in the second composition A. The upper limit is not particularly limited and is 90% by mass or less in many cases.

Note that the solid content refers to a component capable of forming the second cholesteric liquid crystal layer A from which a solvent is removed, and even in a case where the component is liquid, the component is considered as the solid content.

### (Second Surfactant A2)

The second composition A may include a second surfactant A2. The second surfactant A2 is preferably a component that is likely to be condensed on the air interface side of the coating film and can control the alignment of the second liquid crystal compound A during application of the second composition A.

In the first embodiment, the second surfactant A2 is not particularly limited, but a second surfactant B2 used in the second embodiment described below is also preferably used.

In the above-described preferable aspect, the dark line region width/dark line width ratio is likely to be adjusted to be in the above-described range.

The content of the second surfactant A2 with respect to the total solid content of the second composition A is preferably 0.01% to 1% by mass and more preferably 0.05% to 0.5% by mass.

### (Solvent and Other Components)

The second composition A used in the first embodiment may include a solvent and other components.

Since the solvent and the other components that may be included in the second composition A used in the first embodiment are the same as those of the first composition A of the first embodiment, the description thereof will not be repeated.

### <Substrate>

The first embodiment of the laminate may include a substrate.

The substrate is preferably a transparent substrate. The transparent substrate refers to a substrate where a transmittance with respect to a ray in a visible range is 60% or more, and a transmittance thereof is preferably 80% or more and more preferably 90% or more.

As the material forming the substrate, for example, a film formed of cellulose acylate, polycarbonate, polysulfone, polyethersulfone, polyacrylate and polymethacrylate, cyclic polyolefin, polyolefin, polyamide, polystyrene, or polyester can be used. Among these, a cellulose acylate film, cyclic polyolefin, polyacrylate, or polymethacrylate is preferable. In addition, commercially available cellulose acetate films (for example, “TD80U” or “Z-TAC” manufactured by FUJIFILM Corporation) can also be used.

In addition, it is preferable that the support has a small phase difference from the viewpoint of suppressing an adverse effect on the polarization degree of transmitted light and viewpoint of facilitating the optical inspection of the optical film. Specifically, a magnitude of Re is preferably 10 nm or less, and an absolute value of a magnitude of Rth is preferably 50 nm or less.

The substrate may include various additives (for example, an optical anisotropy adjuster, a wavelength dispersion adjuster, fine particles, a plasticizer, an ultraviolet inhibitor, a deterioration inhibitor, and a release agent).

The thickness of the substrate is not particularly limited, and is preferably 10 to 200 μm, more preferably 10 to 100 μm, and still more preferably 20 to 90 μm.

In addition, the substrate may consist of a plurality of layers laminated.

In order to improve adhesion of the substrate with a layer provided thereon, a surface treatment (for example, a glow discharge treatment, a corona discharge treatment, an ultraviolet (UV) treatment, or a flame treatment) may be performed on the surface of the substrate

The first embodiment of the laminate according to the present invention may include other configurations as long as it includes the first cholesteric liquid crystal layer A and the second cholesteric liquid crystal layer A described above.

Examples of the other configurations include a cholesteric liquid crystal layer other than the first cholesteric liquid crystal layer and the second cholesteric liquid crystal layer, a pressure sensitive adhesive layer, an adhesive layer, an alignment layer, an antireflection layer, a retardation layer, and a light-absorbing anisotropic layer.

The first embodiment of the laminate according to the present invention may be in an aspect where the laminate includes three or more cholesteric liquid crystal layers and all of these layers are layers that are sequentially formed on the respective layers by an application treatment using compositions including liquid crystal compounds. Specifically, in a case where the laminate includes a cholesteric liquid crystal layer C1, a cholesteric liquid crystal layer C2, and a cholesteric liquid crystal layer C3 in this order, an aspect may be adopted in which the cholesteric liquid crystal layer C2 is a layer that is formed on the cholesteric liquid crystal layer C1 by an application treatment using a composition including a liquid crystal compound, and the cholesteric liquid crystal layer C3 is a layer that is formed on the cholesteric liquid crystal layer C2 by an application treatment using a composition including a liquid crystal compound. In the above-described aspect, the liquid crystal compound that is included in at least one of the cholesteric liquid crystal layer C1 or the cholesteric liquid crystal layer C2 is a disk-like liquid crystal compound. For example, the liquid crystal compound in the cholesteric liquid crystal layer C1 may be a rod-like liquid crystal compound, the liquid crystal compound in the cholesteric liquid crystal layer C2 may be a disk-like liquid crystal compound, and the liquid crystal compound in the cholesteric liquid crystal layer C3 may be a rod-like liquid crystal compound. In addition, the liquid crystal compound in the cholesteric liquid crystal layer C1 may be a disk-like liquid crystal compound, the liquid crystal compound in the cholesteric liquid crystal layer C2 may be a rod-like liquid crystal compound, and the liquid crystal compound in the cholesteric liquid crystal layer C3 may be a disk-like liquid crystal compound.

In the above-described aspect, the cholesteric liquid crystal layer C2 can correspond to the second cholesteric liquid crystal layer in a relationship with the cholesteric liquid crystal layer C1. In addition, the cholesteric liquid crystal layer C2 can correspond to the first cholesteric liquid crystal layer in a relationship with the cholesteric liquid crystal layer C3.

In a case where the laminate includes three or more cholesteric liquid crystal layers, central wavelengths of light to be reflected from the respective layers may be the same as or different from each other. By laminating the layers where the central wavelengths of light to be reflected from the respective layers are different from each other, for example, light in the entire visible range can be reflected.

In addition, in a case where the laminate is applied to a virtual reality display device, it is preferable that the central wavelengths of light to be reflected from the respective layers are adjusted according to the wavelength of light emitted from the virtual reality display device.

The reflectivity of the laminate with respect to the entire visible range is preferably 40% or more, more preferably 45% or more, still more preferably 47% or more, and still more preferably 49% or more. The upper limit of the reflectivity is, for example, 50% or less.

### <Method of Manufacturing Laminate>

The first embodiment of the laminate can be manufactured, for example, using the following method.

For example, it is possible to adopt a method including: forming the first cholesteric liquid crystal layer A by applying the first composition A to the substrate and aligning and polymerizing the coating film; and forming the second cholesteric liquid crystal layer A by applying the second composition A to the first cholesteric liquid crystal layer A and aligning and polymerizing the coating film.

The alignment treatment is not particularly limited, and examples thereof include a method of applying an electric field to the coating film and a method of heating the coating film. By forming an alignment film before forming the alignment film, the coating film may be formed on the alignment film.

Examples of a method of forming the alignment film include a method of rubbing a film that is formed of a well-known material, and the method of rubbing the coating film is preferable. The direction of the rubbing treatment is not particularly limited, and an optimum direction is appropriately selected according to the direction in which the liquid crystal compound is desired to be aligned. In addition, by rubbing the substrate where the coating film is to be formed, the coating film may be formed on the rubbed substrate.

As the rubbing treatment, a treatment method that is widely adopted as an alignment treatment step of an alignment film of a liquid crystal display (LCD) can be applied. Specifically, a method of rubbing the surface of the alignment film or the resin substrate in a certain direction with paper, gauze, felt, rubber, nylon fiber, polyester fiber, or the like can be used.

The polymerization treatment is not particularly limited, and a method of ultraviolet irradiation is preferable. It is preferable that the ultraviolet irradiation is performed in an environment having a low oxygen concentration. In the present specification, “ultraviolet rays” refers to electromagnetic waves mainly including electromagnetic waves having a wavelength of 200 to 400 nm, and it is preferable that the electromagnetic waves mainly include electromagnetic waves having a wavelength of 300 to 400 nm. A light source of the ultraviolet rays is not particularly limited, and a well-known light source can be used.

Irradiation with ultraviolet rays including any wavelength range may be performed of a filter or the like. Examples of the light source of the ultraviolet rays include a high-pressure mercury lamp, a metal halide lamp, and a light emitting diode (LED).

The irradiation energy is preferably 5 mJ/cm² to 100 J/cm², more preferably 30 to 600 mJ/cm², and still more preferably 100 to 400 mJ/cm². In order to promote the photopolymerization reaction, the light irradiation may be performed under heating conditions.

After forming the second cholesteric liquid crystal layer A, in order reduce the effect of the surfactant on another layer formed on the second cholesteric liquid crystal layer A, a surface treatment (for example, a corona discharge treatment) may be performed on the surface of the second cholesteric liquid crystal layer A. For example, in a case where the corona discharge treatment is performed on the surface of the second cholesteric liquid crystal layer A, the effect of the second surfactant A2 that may be present in the vicinity of the surface of the second cholesteric liquid crystal layer A can be reduced. In a case where the corona discharge treatment is performed on the surface of the second cholesteric liquid crystal layer A, it is preferable that the second composition A used for forming the second cholesteric liquid crystal layer A includes a rod-like liquid crystal compound as the second liquid crystal composition A.

It is preferable that, after forming the first cholesteric liquid crystal layer A, a surface treatment (for example, a corona discharge treatment) is not performed on the surface of the first cholesteric liquid crystal layer A. That is, it is preferable that, after forming the first cholesteric liquid crystal layer A, the second composition A is applied without performing the surface treatment. The reason for this is that, in a case where the above-described treatment is performed, the aligning properties of the second cholesteric liquid crystal layer A may decrease. More specifically, in general, in a case where a liquid crystal layer including a rod-like liquid crystal compound is formed on a liquid crystal layer including a disk-like liquid crystal compound, the corona treatment is performed on the surface of the liquid crystal layer including the disk-like liquid crystal compound such that the surface is hydrophilic. In a case where the layer including the rod-like liquid crystal compound is formed in a state where the surface of the liquid crystal layer including the disk-like liquid crystal compound is hydrophilic, the rod-like liquid crystal compound is likely to be hydrophobic. Therefore, the aligning properties of the rod-like liquid crystal compound may decrease.

### [Second Embodiment of Laminate]

The second embodiment of the laminate according to the present invention is a laminate including: a first cholesteric liquid crystal layer B that is formed of a first composition B including a first liquid crystal compound B; and a second cholesteric liquid crystal layer B that is formed on the first cholesteric liquid crystal layer B by an application treatment using a second composition B including a second liquid crystal compound B. Here, the first liquid crystal compound B in the first composition B is a disk-like liquid crystal compound, and the first liquid crystal compound B is a compound different from the second liquid crystal compound B. In addition, the second cholesteric liquid crystal layer B includes a surfactant, and the number of aggregates of the surfactant having a major axis diameter of 0.5 μm or more in a surface of the second cholesteric liquid crystal layer B opposite to the first cholesteric liquid crystal layer B side is less than 10000 aggregates/mm².

The cholesteric liquid crystal layer refers to a layer obtained by immobilizing a cholesterically aligned liquid crystal compound.

The aggregates of the surfactant in the second embodiment of the laminate will be described below.

The number of aggregates of the surfactant having a major axis diameter of 0.5 μm or more in the surface of the second cholesteric liquid crystal layer B of the laminate opposite to the first cholesteric liquid crystal layer B side (hereinafter, also simply referred to as “the surface of the second cholesteric liquid crystal layer B”) is obtained as follows.

First, the surface of the second cholesteric liquid crystal layer B of the laminate is analyzed by time-of-flight secondary ion mass spectrometry (TOF-SIMS) to acquire mapping data of a mass spectrum in the analysis region. The TOF-SIMS is specifically described in “Surface Analysis Technology Library Secondary Ion Mass Spectrometry” edited by the Surface Science Society of Japan and published by Maruzen Co., Ltd. (1999).

The detailed conditions of the analysis by the TOF-SIMS can be measured, for example, under conditions described in Examples below.

In the above-described analysis, the analysis region (for example, 40 square μm) is divided into 256 compartments lengthwise and crosswise, and each of the compartments of the analysis region is irradiated with an ion beam to obtain a mass spectrum of secondary ions derived from the surface of the second cholesteric liquid crystal layer B. At this time, in a case where a detection intensity of secondary ions corresponding to the secondary ions derived from the surfactant in the second cholesteric liquid crystal layer B is mapped, whether or not the aggregates of the surfactant are present can be verified. The secondary ions derived from the surfactant refer to fragment-ions derived from the surfactant.

As the secondary ions to be mapped, the secondary ions derived from the surfactant may be appropriately selected depending on the kind of the surfactant and the components in the second cholesteric liquid crystal layer B, and are not limited to ion species described below.

Examples of the secondary ions derived from the surfactant include secondary ions (fragment-ions) derived from a group in the surfactant, and examples of the group in the surfactant include a fluorinated alkyl group, a fluorinated alkyloxy group, a fluorinated polyether group, and an organic group having a siloxane bond (for example, a group having a polysiloxane chain having an alkyl group, a group having a polysiloxane chain having a fluorinated alkyl group, a group having a polysiloxane chain having an acryloyl group, or the like). The fluorinated alkyl group in the above-described exemplary groups may be a perfluoroalkyl group where all of hydrogen atoms of the alkyl groups are substituted with fluorine atoms or may be a partially fluorinated alkyl group where hydrogen atoms of the alkyl groups are partially substituted with fluorine atoms.

Next, in an image where the detection intensity of the secondary ions corresponding to the secondary ions derived from the surfactant are mapped, whether or not there are regions where portions having a high detection intensity are unevenly distributed and aggregates of the surfactant are recognized is verified. Regarding each of the regions where the aggregates of the surfactant are recognized, a distance between two parallel lines in contact with the region that are disposed such that the distance is the maximum is set as the major axis diameter of the aggregate of the surfactant. Through the above-described procedure, the number of aggregates of the surfactant having a major axis diameter of 0.5 μm or more in the analysis region is counted.

The counting of the number of the aggregates having a major axis diameter of 0.5 μm or more in the analysis region is performed in other regions of the second cholesteric liquid crystal layer B, and the number of the aggregates is counted at ten positions. The arithmetic mean of the numbers of the aggregates obtained in the ten times of the counting of the aggregates is divided by the area of the analysis region to calculate the number (unit: aggregates/mm²) of the aggregates per unit area.

In the second embodiment of the laminate according to the present invention, the number of the aggregates per unit area obtained as described above is less than 10000 aggregates/mm². The number of the aggregates per unit area is preferably 1000 aggregates/mm² or less and more preferably 100 aggregates/mm² or less. The lower limit of the number of the aggregates per unit area is, for example, 0 aggregates/mm² or more.

In a case where the surface of the second cholesteric liquid crystal layer B opposite to the first cholesteric liquid crystal layer B side is not exposed, by performing the analysis by TOF-SIMS while cutting the outermost surface of the laminate by irradiation with an ion beam, the number of the aggregates in the surface of the second cholesteric liquid crystal layer B opposite to the first cholesteric liquid crystal layer B side is obtained.

In a case where the number of aggregates of the surfactant having a major axis diameter of 0.5 μm or more in a surface of the second cholesteric liquid crystal layer B opposite to the first cholesteric liquid crystal layer B side is less than 10000 aggregates/mm², the mechanism for increasing the reflectivity of the cholesteric liquid crystal layer is not necessarily clear but is presumed to be as follows. That is, it is considered that, in a case where the number of the aggregates of the surfactant is in the above-described range, the surfactant is likely to effectively act, and the alignment of the second liquid crystal compound B in the second cholesteric liquid crystal layer B is not likely to be disordered. As a result, it is considered that reflection from the second liquid crystal compound B in an unintended direction caused by the disorder of the alignment of the second liquid crystal compound B is suppressed, and the reflectivity of the cholesteric liquid crystal layer is not high.

Hereinafter, each of the configurations of the second embodiment of the laminate and a material used in each of the configurations will be described.

### <First Cholesteric Liquid Crystal Layer B>

The second embodiment of the laminate according to the present invention includes the first cholesteric liquid crystal layer B that is formed of the first composition B including the first liquid crystal compound B. That is, the first cholesteric liquid crystal layer B is a layer obtained by immobilizing the cholesterically aligned first liquid crystal compound B. Accordingly, the first cholesteric liquid crystal layer B may include a component derived from a component in the first composition B described below.

The layer obtained by immobilizing the cholesterically aligned first liquid crystal compound B may be a layer that is changed to a state in which the alignment is not changed by an external field, an external force, or the like. In the first cholesteric liquid crystal layer B, optical characteristics of the cholesteric liquid crystalline phase only need to be maintained in the layer, and the first liquid crystal compound B in the first cholesteric liquid crystal layer B does not need to be liquid-crystalline any more. For example, the molecular weight of the first liquid crystal compound B may increase due to a curing reaction such that the liquid crystallinity thereof is lost.

The first cholesteric liquid crystal layer B can reflect electromagnetic waves (light) in a specific wavelength range using the cholesterically aligned first liquid crystal compound B. A central wavelength λ of light to be reflected from the first cholesteric liquid crystal layer B depends on a pitch P of a helical structure (=the period of the helix) in the cholesteric liquid crystalline phase, and is expressed by a relationship of λ=n×P with an average refractive index n of the first cholesteric liquid crystal layer B. The central wavelength of light to be reflected from the first cholesteric liquid crystal layer B can be obtained as in the central wavelength of light to be reflected from the first cholesteric liquid crystal layer A of the first embodiment.

The central wavelength λ of light to be reflected from the first cholesteric liquid crystal layer B is not particularly limited and is preferably in a visible range.

The reflectivity of the first cholesteric liquid crystal layer B at the central wavelength λ is preferably 40% or more, more preferably 45% or more, still more preferably 47% or more, and still more preferably 49% or more. The upper limit of the reflectivity is, for example, 50% or less.

The thickness of the first cholesteric liquid crystal layer B is preferably 0.1 to 10 μm and more preferably 0.3 to 5 μm.

### <First Composition B>

The first composition B used for forming the first cholesteric liquid crystal layer B includes the first liquid crystal compound B. It is preferable that the first composition B includes the first surfactant B1.

Hereinafter, the components in the first composition B and component that may be included in the first composition B will be described.

### (First Liquid Crystal Compound B)

The first liquid crystal compound B is not particularly limited as long as it is a disk-like liquid crystal compound, and a well-known disk-like liquid crystal compound can be used. Note that, as the first liquid crystal compound B, a compound different from the second liquid crystal compound B described below is selected. Examples of a method of cholesterically aligning the first liquid crystal compound B include a method of using the first composition B including the first liquid crystal compound B and a chiral agent.

The first liquid crystal compound B may be a polymerizable liquid crystal compound having a polymerizable group. The first liquid crystal compound B is preferably a polymerizable disk-like liquid crystal compound.

Since examples of the compound used as the first liquid crystal compound B are the same as the examples of the first liquid crystal compound A of the first embodiment, the description thereof will not be repeated.

### (First Surfactant B1)

The first composition B may include the first surfactant B1. The first surfactant B1 is preferably a component that is likely to be condensed on the air interface side of the coating film and can control the alignment of the first liquid crystal compound B during application of the first composition B.

It is also preferable that the first surfactant B1 is liquid-crystalline and has a phase transition temperature of 100° C. or higher from a liquid crystal phase to an isotropic liquid phase, or the first surfactant B1 is non-liquid-crystalline and has a melting point of 90° C. or higher. In a case where the above-described characteristics are satisfied, it is considered that, in a case where the first cholesteric liquid crystal layer B is formed on the substrate through a roll-to-roll process, the first surfactant B1 is not likely to be transferred to the surface of the substrate opposite to the first cholesteric liquid crystal layer B side. In a case where the first surfactant B1 is not likely to be transferred to the substrate, the coating film is likely to be uniform during the formation of the second cholesteric liquid crystal layer B, and in a case where the obtained laminate is used for a virtual reality display device, an image can be clearly recognized.

It is preferable that the first surfactant B1 is not likely to be transferred to the substrate. The amount of the first surfactant B1 transferred to the substrate can be estimated using the following method. Hereinafter, a method for a case where the first surfactant B1 includes a fluoroalkyl group will be described.

First, the first cholesteric liquid crystal layer is formed on the substrate. Next, the substrate with the first cholesteric liquid crystal layer is laminated such that the surface of the formed first cholesteric liquid crystal layer opposite to the substrate and the surface of the substrate opposite to the first cholesteric liquid crystal layer face each other. In the laminated state, a weight is placed on the substrate side in an environment of 45° C. to apply a pressure of 0.01 MPa for 3 days. Next, in the substrate surface in contact with the surface of the first cholesteric liquid crystal layer opposite to the substrate, the fluorine content is analyzed by X-ray photoelectron spectroscopy.

The content of fluorine atoms analyzed by X-ray photoelectron spectroscopy with respect to all the atoms is preferably 10% by atom or less, more preferably 5% by atom or less, and still more preferably 2% by atom or less. The lower limit of the content of the fluorine atoms is, for example, 0% by atom or more.

From the viewpoint of high solubility in the second composition B described below and the formed coating film, the first surfactant B1 is preferably a low-molecular-weight compound not including a repeating unit, and the molecular weight of the first surfactant B1 that is a low-molecular-weight compound is preferably 5000 or lower. The molecular weight of the first surfactant B1 that is a low-molecular-weight compound is more preferably 1000 to 5000 and still more preferably 2000 to 4000.

In addition, from the viewpoint of alignment controllability of the first liquid crystal compound B, it is preferable the first surfactant B1 includes three or more aromatic ring structures, and it is more preferable that the first surfactant B1 includes four or more aromatic ring structures. Even in a case where the aromatic ring structure is a fused-ring structure (for example, a naphthalene ring), the number of the aromatic ring structures is one. Note that, in a case where the aromatic ring structure is a fused-ring structure and the fused-ring structure is a phenanthrene ring, a fluorene ring, or an anthracene ring, the number of aromatic ring structures in the fused-ring structure is 2.

From the viewpoint that the first surfactant B1 is likely to be condensed on the air interface side of the coating film and has high solubility in the second composition B described below and the formed coating film, it is preferable that the first surfactant B1 has a fluoroalkyl group, and it is more preferable that the first surfactant B1 has a linear perfluoroalkyl group.

More specifically, it is preferable that the first surfactant B1 is a compound represented by Formula (11).

$${( {( Rf )}_{p 1} - {A}_{11} )}_{q 1} - {X}_{12} - {( {L}_{13} - {X}_{130} )}_{r 1} - {L}_{14} - {X}_{14} \qquad ( 11 )$$

In Formula (11), Rf represents a linear perfluoroalkyl group.

In a case where two or more Rf's are present in Formula (11), Rf's may represent the same group or different groups and preferably represent the same group.

The number of carbon atoms in the linear perfluoroalkyl group is preferably 2 to 8, more preferably 3 to 6, and still more preferably 4.

In Formula (11), the number of Rf's is preferably 2 to 9, more preferably 3 to 6, and still more preferably 3 or 4.

In Formula (11), p1 represents an integer of 1 to 3. In particular, p1 preferably represents 1 or 2.

In Formula (11), A₁₁'s each independently represent a (p1+1)-valent hydrocarbon group. The (p1+1)-valent hydrocarbon group may include one or more kinds of atoms selected from the group consisting of an oxygen atom and a nitrogen atom.

The number of carbon atoms in the (p1+1)-valent hydrocarbon group represented by An is preferably 2 to 40 and more preferably 3 to 30.

It is preferable that the (p1+1)-valent hydrocarbon group represented by A₁₁ includes an aliphatic hydrocarbon structure, an aromatic hydrocarbon structure, and a structure including a combination of these structures.

The aliphatic hydrocarbon structure may be linear or branched or may include a cyclic structure. The number of carbon atoms in the aliphatic hydrocarbon structure is preferably 2 to 10 and more preferably 2 to 6.

Examples of the aromatic hydrocarbon structure include a benzene structure and a naphthalene structure. In particular, a benzene structure is preferable.

The (p1+1)-valent hydrocarbon group represented by Au may include two or more atoms of one or more kinds selected from the group consisting of an oxygen atom and a nitrogen atom.

In Formula (11), q1 represents an integer of 2 to 4.

A plurality of p1's and A₁₁'s may be different from or the same as each other, but are preferably the same as each other.

It is also preferable that q1 and p1 are set such that the number of Rf's is in the above-described preferable range. For example, in a case where p1 represents 1, q1 represents preferably 3, in a case where p1 represents 2, q1 represents preferably 2 or 3, and in a case where p1 represents 3, q1 represents preferably 2.

In Formula (11), X₁₂ represents a (q1+1)-valent aromatic ring group.

The (q1+1)-valent aromatic ring group represented by X₁₂ may have a monocyclic structure or a polycyclic structure.

The (q1+1)-valent aromatic ring group represented by X₁₂ may include a heteroatom other than a carbon atom (for example, one or more kinds of atoms selected from the group consisting of a nitrogen atom, an oxygen atom, and a sulfur atom).

Examples of the (q1+1)-valent aromatic ring group represented by X₁₂ include a group where q1+1 hydrogen atoms are removed from a compound selected from the group consisting of benzene and naphthalene.

In Formula (11), X₁₃'s each independently represent a divalent aromatic ring group that may include a substituent.

The aromatic ring group represented by X₁₃ may have a monocyclic structure or a polycyclic structure.

The aromatic ring group represented by X₁₃ may include a heteroatom other than a carbon atom (for example, one or more kinds of atoms selected from the group consisting of a nitrogen atom, an oxygen atom, and a sulfur atom).

Examples of the aromatic ring group represented by X₁₃ include a group obtained by removing two hydrogen atoms from a compound selected from the group consisting of benzene, naphthalene, anthracene, phenanthrene, and 1,2,4-oxadiazole. The position where the hydrogen atoms are removed is not particularly limited. For example, in a case where the aromatic ring group represented by X₁₃ is a group obtained by removing two hydrogen atoms from benzene, the position of one hydrogen atom with respect to the other hydrogen atom may be any position, and is preferably the para-position.

In addition, in a case where the aromatic ring group represented by X₁₃ is a group obtained by removing two hydrogen atoms from naphthalene, the position of one hydrogen atom with respect to the other hydrogen atom may be any of the ortho-position (1,2-position), the meta-position (1,3-position), the para-position (1,4-position), the ana-position (1,5-position), the epi-position (1,6-position), the kata-position (1,7-position), the peri-position (1,8-position), the proso-position (2,3-position), or the amphi-position (2,6-position), and is preferably the para-position, the ana-position, or the amphi-position.

Examples of a substituent that may be included in the aromatic ring group represented by X₁₃ include one or more kinds of substituents selected from the group consisting of —CN, —R₃, —OR₃, —OH, —(CH₂)ₘ—OH, —F, —COOR₃, and —COR₃. R₃ represents a linear or branched alkyl group having 1 to 20 carbon atoms. m represents an integer of 1 to 3. The number of carbon atoms in the alkyl group represented by R₃ is preferably 1 to 6 and more preferably 1 to 4. Examples of the alkyl group represented by R₃ include a methyl group, an ethyl group, a 1-propyl group, a 2-propyl group, a 1-butyl group, and a t-butyl group.

The substituent that may be included in the aromatic ring group represented by X₁₃ is preferably one or more kinds of substituents selected from the group consisting of —R₃, —OR₃, —COOR₃, and —COR₃.

In Formula (11), L₁₃ and L₁₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—. R₁ represents a hydrogen atom or an alkyl group having 1 to 3 carbon atoms. n represents an integer of 1 to 3,
L₁₃ represents preferably a single bond, —COO—, —CONR₁—, —O—, or —COO—(CH₂)ₙ—, more preferably a single bond, —COO—, or —CONR₁—, still more preferably a single bond or —COO—, and still more preferably —COO-.
L₁₄ represents preferably a single bond, —CO—, —COO—, —CONR₁—, —O—, —(CH₂)ₙ—, —O—(CH₂)ₙ—, —COO—(CH₂)ₙ—, —CO—CH═CH—, or —C≡C—, more preferably a single bond, —COO—, or —CONR₁—, still more preferably a single bond or —COO—, and still more preferably —COO-.

In Formula (11), r1 represents an integer of 0 to 4. In a case where L₁₄ represents —COO—CH₂—, r1 represents 0.

In a case where r1 represents 2 or more, the groups represented by L₁₃ and X₁₃ may be the same as or different from each other.

r1 represents preferably 1 to 3 and more preferably 1 or 2.

In addition, in Formula (11), it is also preferable that r1 represents 2 or more or that r1 represents 1 and X₁₃ represents a divalent aromatic ring group having a plurality of ring structures.

In Formula (11), X₁₄ represents a monovalent aromatic ring group that may be substituted with —CN, —Ra, —OR₂, —OH, —(CH₂)ₘ—OH, —F, or —COOR₂, or represents a group having the following structure.

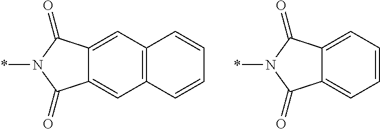

In the following structure, * represents a bonding position to L₁₄.

R₂ represents a linear or branched alkyl group having 1 to 20 carbon atoms. m represents an integer of 1 to 3.

The number of carbon atoms in the alkyl group represented by R₂ is preferably 1 to 12 and more preferably 1 to 8. Examples of the alkyl group represented by R₂ include a methyl group, an ethyl group, a propyl group, a butyl group, a hexyl group, a heptyl group, and an octyl group. It is preferable that R₂ represents a linear alkyl group.

It is also preferable that the substituent that may be included in the aromatic ring group is selected depending on the liquid crystal compound used in the liquid crystal composition described below.

The aromatic ring group represented by X₁₄ may have a monocyclic structure or a polycyclic structure.

The aromatic ring group represented by X₁₄ may include a heteroatom other than a carbon atom (for example, one or more kinds of atoms selected from the group consisting of a nitrogen atom, an oxygen atom, and a sulfur atom).

Examples of the monocyclic structure include a phenyl group and a pyridyl group.

Examples of the polycyclic structure include a naphthyl group, an anthracenyl group, a phenanthrenyl group, a fluorenyl group, a benzofuranyl group, a benzimidazolyl group, and a benzothiazolyl group.

It is also preferable that the aromatic ring group represented by X₁₄ does not include the above-described substituent.

It is also preferable that the first surfactant B1 represented by Formula (11) is a compound represented by Formula (12).

$${{( {( Rf )}_{p 1} - {L}_{21} )}_{p 2} - {X}_{21} - {L}_{22} )}_{q 2} - {X}_{22} - {( {L}_{23} - {X}_{23} )}_{r 2} - {L}_{24} - {X}_{24} \qquad ( 12 )$$

In Formula (12), Rf represents a linear perfluoroalkyl group.

In a case where two or more Rf's are present in Formula (12), Rf's may represent the same group or different groups and preferably represent the same group.

The number of carbon atoms in the linear perfluoroalkyl group is preferably 2 to 8, more preferably 3 to 6, and still more preferably 4.

In Formula (12), the number of Rf's is preferably 2 to 9, more preferably 3 to 6, and still more preferably 3 or 4.

In Formula (12), p2 represents an integer of 1 to 3.

In Formula (12), X₂₁ represents a single bond, a (p2+1)-valent aromatic ring group, or a (p2+1)-valent aliphatic hydrocarbon group having 3 to 10 carbon atoms.

The (p2+1)-valent aromatic ring group represented by X₂₁ may have a monocyclic structure or a polycyclic structure.

Examples of the (p2+1)-valent aromatic ring group represented by X₂₁ include a group where p2+1 hydrogen atoms are removed from a compound selected from the group consisting of benzene and naphthalene. Among these, a group obtained by removing p2+1 hydrogen atoms from benzene is preferable.

The (p2+1)-valent aliphatic hydrocarbon group represented by X₂₁ having 3 to 10 carbon atoms may be linear or branched or may include a cyclic structure.

Examples of the (p2+1)-valent aliphatic hydrocarbon group having 3 to 10 carbon atoms represented by X₂₁ include a group obtained by removing p2+1 hydrogen atoms from a compound selected from the group consisting of n-propane, n-butane, n-pentane, n-hexane, isobutane, 3-ethylpentane, neopentane, neohexane, cyclobutane, and cyclohexane. Among these, a group obtained by removing p2+1 hydrogen atoms from n-propane is preferable.

In a case where X₂₁ represents a single bond, p2 represents 1.

In Formula (12), L₂₁ represents a divalent linking group represented by any of Formulae (2-1) to (2-4).

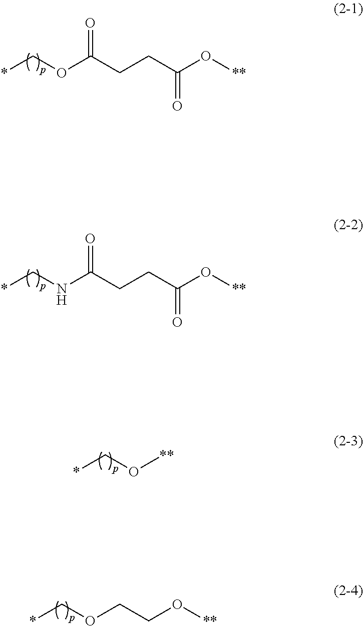

In Formulae (2-1) to (2-4), p represents an integer of 1 to 3.

In Formulae (2-1) to (2-4), ** represents a bonding position to X₂₁, and * represents a bonding position to Rf.

In Formula (12), q2 represents an integer of 2 to 4.

A plurality of p2's, L₂₁'s, X₂₁'s, and L₂₂'s may be different from each other or may be the same as each other, but are preferably the same as each other.

It is also preferable that q2 and p2 are set such that the number of Rf's is in the above-described preferable range. For example, in a case where p2 represents 1, q2 represents preferably 3, in a case where p2 represents 2, q2 represents preferably 2 or 3, and in a case where p2 represents 3, q2 represents preferably 1 or 2.

In Formula (12), X₂₂ represents a (q2+1)-valent aromatic ring group.

The (q2+1)-valent aromatic ring group represented by X₂₂ may have a monocyclic structure or a polycyclic structure.

Examples of the (q2+1)-valent aromatic ring group represented by X₂₂ include the (q1+1)-valent aromatic ring group represented by X₁₂, and a preferable aspect thereof is also the same.

In Formula (12), X₂₃'s each independently represent a divalent aromatic ring group that may include a substituent.

The aromatic ring group represented by X₂₃ may have a monocyclic structure or a polycyclic structure.

Examples of the aromatic ring group represented by X₂₃ include the aromatic ring group represented by X₁₃, and a preferable aspect thereof is also the same.

In addition, the substituent that may be included in X₂3 is the same as the substituent that may be included in X₁₃, and a preferable aspect thereof is also the same.

In Formula (12), L₂₂, L₂₃ and L₂₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—. R₁ represents a hydrogen atom or an alkyl group having 1 to 3 carbon atoms. n represents an integer of 1 to 3.

L₂₂ represents preferably a single bond, —COO—, —CONR₁—, —O—, or —COO—(CH₂)ₙ—, and more preferably a single bond, —O—, or —COO—.

L₂₃ represents preferably a single bond, —COO—, —CONR₁—, —O—, or —COO—(CH₂)ₙ—, more preferably a single bond, —COO—, or —CONR₁—, still more preferably a single bond or —COO—, and still more preferably —COO—.

L₂₄ represents preferably a single bond, —CO—, —COO—, —CONR₁—, —O—, —(CH₂)ₙ—, —O—(CH₂)ₙ—, —COO—(CH₂)ₙ—, —CO—CH═CH—, or —C≡C—, more preferably a single bond, —COO—, or —CONR₁—, still more preferably a single bond or —COO—, and still more preferably —COO—.

In Formula (12), r2 represents an integer of 0 to 4. In a case where L₂₄ represents —CO—O—CH₂—, r2 represents 0. r2 represents preferably 1 to 3.

In Formula (12), X₂₄ represents a monovalent aromatic ring group that may be substituted with —CN, —R₂, —OR₂, —OH, —(CH₂)ₘ—OH, —F, or —OCOOR₂. R₂ represents a linear or branched alkyl group having 1 to 20 carbon atoms. m represents an integer of 1 to 3.

Specific examples and a preferable aspect of R₂ are the same as those of R₂ described in Formula (11).

The aromatic ring group represented by X₂₄ may have a monocyclic structure or a polycyclic structure.

The aromatic ring group represented by X₂₄ may include a heteroatom other than a carbon atom (for example, one or more kinds of atoms selected from the group consisting of a nitrogen atom, an oxygen atom, and a sulfur atom). Specific examples and a preferable aspect of the aromatic ring group represented by X₂₄ are the same as those of X₁₄ in Formula (11).

Since the first surfactant B1 represented by Formula (11) is a low-molecular-weight compound not having a repeating unit, it is considered that the solubility in the second composition B described below and the formed coating film is high. Further, since a group similar to a rigid unit (for example, a group having an aromatic ring group called a mesogen group) in a liquid crystal structure is present in the molecule, it is considered that the alignment controllability for the first liquid crystal compound B is high.

By using the first surfactant B1 represented by the above-described formula, in a case where the second cholesteric liquid crystal layer B is formed on the formed first cholesteric liquid crystal layer B by an application treatment, the solubility of the first surfactant B1 in the second composition B is high. As a result, the second composition B can be applied without unevenness, and the second cholesteric liquid crystal layer B is likely to be formed without unevenness. In addition, it is considered that the first surfactant B1 in which the second composition B is dissolved is condensed on the air interface side of the coating film of the second composition B. In this case, since the solubility in the coating film formed of the second composition B is high, aggregates derived from the first surfactant B1 are not likely to be formed. As a result, by using the first surfactant B1 for forming the first cholesteric liquid crystal layer B, the number of the aggregates of the surfactant of the second cholesteric liquid crystal layer B is likely to be adjusted in the range.

### (Solvent and Other Components)

The first composition B used in the second embodiment may include a solvent and

other components.

Since the solvent and the other components that may be included in the first composition B used in the second embodiment are the same as those of the first composition A of the first embodiment, the description thereof will not be repeated.

### <Second Cholesteric Liquid Crystal Layer B>

The second embodiment of the laminate according to the present invention includes the second cholesteric liquid crystal layer B that is formed on the first cholesteric liquid crystal layer B by the application treatment using the second composition including the second liquid crystal compound B. That is, the second cholesteric liquid crystal layer B is a layer obtained by immobilizing the cholesterically aligned second liquid crystal compound B. Accordingly, the second cholesteric liquid crystal layer B may include a component derived from a component in the second composition B described below.

The layer obtained by immobilizing the cholesterically aligned second liquid crystal compound B may be a layer that is changed to a state in which the alignment is not changed by an external field, an external force, or the like. In the second cholesteric liquid crystal layer B, optical characteristics of the cholesteric liquid crystalline phase only need to be maintained in the layer, and the second liquid crystal compound B in the second cholesteric liquid crystal layer B does not need to be liquid-crystalline any more. For example, the molecular weight of the second liquid crystal compound B may increase due to a curing reaction such that the liquid crystallinity thereof is lost.

The second cholesteric liquid crystal layer B can reflect electromagnetic waves (light) in a specific wavelength range using the cholesterically aligned second liquid crystal compound B. A central wavelength λ of light to be reflected from the second cholesteric liquid crystal layer B depends on a pitch P of a helical structure (=the period of the helix) in the cholesteric liquid crystalline phase, and is expressed by a relationship of λ=n×P with an average refractive index n of the second cholesteric liquid crystal layer B. The central wavelength of light to be reflected from the second cholesteric liquid crystal layer B can be obtained as in the central wavelength of light to be reflected from the first cholesteric liquid crystal layer A.

The central wavelength λ of light to be reflected from the second cholesteric liquid crystal layer B is not particularly limited and is preferably in a visible range.

The reflectivity of the second cholesteric liquid crystal layer B at the central wavelength λ is preferably 40% or more, more preferably 45% or more, still more preferably 47% or more, and still more preferably 49% or more. The upper limit of the reflectivity is, for example, 50% or less.

In addition, the second cholesteric liquid crystal layer B includes a surfactant.

As described above, in the laminate according to the second embodiment, the number of aggregates of the surfactant having a major axis diameter of 0.5 μm or more in a surface of the second cholesteric liquid crystal layer B opposite to the first cholesteric liquid crystal layer B side is less than 25 aggregates/mm², and preferably 10 aggregates/mm² or less. The lower limit of the number of the aggregates having a major axis diameter of 0.5 μm or more is, for example, 0 aggregates/mm² or more.

It is preferable that the surfactant in the second cholesteric liquid crystal layer B includes the first surfactant and the second surfactant that are different in kind.

The first surfactant is preferably the first surfactant B1 in the first composition B used for forming the first cholesteric liquid crystal layer B. In addition, the second surfactant is preferably the second surfactant B2 in the second composition B used for forming the second cholesteric liquid crystal layer B.

The thickness of the second cholesteric liquid crystal layer B is preferably 0.1 to 10 μm and more preferably 0.3 to 5 μm.

### <Second Composition B>

The second composition B used for forming the second cholesteric liquid crystal layer B includes the second liquid crystal compound B.

Hereinafter, the components in the second composition B and component that may be included in the second composition B will be described.

### (Second Liquid Crystal Compound B)

The second liquid crystal compound B is not particularly limited, and a well-known liquid crystal compound can be used. Note that, as the second liquid crystal compound B, a compound different from the first liquid crystal compound B described below is selected. Examples of the liquid crystal compound include a rod-like liquid crystal compound and a disk-like liquid crystal compound. Examples of a method of cholesterically aligning the second liquid crystal compound B include a method of using the first composition B including the second liquid crystal compound B and a chiral agent.

The second liquid crystal compound B may be a polymerizable liquid crystal compound having a polymerizable group.

As the second liquid crystal compound B, a disk-like liquid crystal compound is preferable, and a polymerizable disk-like liquid crystal compound is more preferable.

Since examples of the compound used as the second liquid crystal compound B are the same as the examples of the second liquid crystal compound A of the first embodiment, the description thereof will not be repeated.

### (Second Surfactant B2)

The second composition B may include the second surfactant B2. The second surfactant B2 is preferably a component that is likely to be condensed on the air interface side of the coating film and can control the alignment of the second liquid crystal compound B during application of the second composition B.

Examples of the second surfactant B2 include a well-known surfactant of the related art. In particular, a fluorine compound is preferable.

As the fluorine compound, a polymeric fluorine compound that includes a repeating unit having a fluorine-containing group is preferable. As the fluorine-containing group in the repeating unit having the fluorine-containing group, a fluorine-containing alkyl group is preferable. The fluorine-containing alkyl group may be a perfluoroalkyl group or a partially fluorinated alkyl group. The polymeric fluorine compound may include a repeating unit other than the repeating unit having the fluorine-containing group. Examples of the other repeating units include a repeating unit having a ring structure. Examples of the group having the ring structure include a group having an aromatic ring structure and a group having an alicyclic structure. The ring structure may include a heteroatom other than an oxygen atom (for example, a sulfur atom and a nitrogen atom) between carbon atoms.

Examples of the fluorine compound include compounds described in paragraphs “0028” to “0056” of JP2001-330725A and compounds described in paragraphs “0069” to “0126” of JP2005-062673A.

The second surfactant B2 may be a compound described in the first surfactant B1.

### (Solvent and Other Components)

The second composition B used in the second embodiment may include a solvent and other components.

Since the solvent and the other components that may be included in the second composition B used in the second embodiment are the same as those of the first composition A of the first embodiment, the description thereof will not be repeated.

### <Substrate>

The second embodiment of the laminate may include a substrate.

Since a preferable aspect of the substrate that may be included in the second embodiment of the laminate is the same as the preferable aspect of the substrate that may be included in the first embodiment, the description thereof will not be repeated.

The second embodiment of the laminate according to the present invention may include other configurations as long as it includes the first cholesteric liquid crystal layer B and the second cholesteric liquid crystal layer B described above.

Examples of the other configurations include a cholesteric liquid crystal layer other than the first cholesteric liquid crystal layer B and the second cholesteric liquid crystal layer B, a pressure sensitive adhesive layer, an adhesive layer, an alignment layer, an antireflection layer, a retardation layer, and a light-absorbing anisotropic layer.

In addition, in a case where the laminate is applied to a virtual reality display device, it is preferable that the central wavelengths of light to be reflected from the respective layers are adjusted according to the wavelength of light emitted from the virtual reality display device.

The reflectivity of the laminate with respect to the entire visible range is preferably 40% or more, more preferably 45% or more, still more preferably 47% or more, and still more preferably 49% or more. The upper limit of the reflectivity is, for example, 50% or less.

### <Method of Manufacturing Laminate>

The second embodiment of the laminate can be manufactured, for example, using the following method.

For example, it is possible to adopt a method including: forming the first cholesteric liquid crystal layer B by applying the first composition B to the substrate and aligning and polymerizing the coating film; and forming the second cholesteric liquid crystal layer B by applying the second composition B to the first cholesteric liquid crystal layer B and aligning and polymerizing the coating film.

Examples of the alignment treatment include a heating treatment. Examples of the polymerization treatment include an irradiation treatment of an actinic ray. In addition, in a case where the first composition B or the second composition B includes a solvent, a treatment of removing the solvent in the coating film may be performed.

In order to allow the second cholesteric liquid crystal layer B to include the surfactant, the second composition B including the surfactant may be used, or the first composition B including a surfactant having high solubility in the second composition B may be used to form the first cholesteric liquid crystal layer B.

In addition, the surface treatment, the alignment treatment, and the polymerization treatment are the same as those of the method of manufacturing the laminate described in the first embodiment.

It is preferable that, after forming the first cholesteric liquid crystal layer B, a surface treatment (for example, a corona discharge treatment) is not performed on the surface of the first cholesteric liquid crystal layer B. That is, it is preferable that, after forming the first cholesteric liquid crystal layer B, the second composition B is applied without performing the surface treatment. The reason for this is that, in a case where the above-described treatment is performed, the aligning properties of the second cholesteric liquid crystal layer B may decrease. More specifically, in general, in a case where a liquid crystal layer including a rod-like liquid crystal compound is formed on a liquid crystal layer including a disk-like liquid crystal compound, the corona treatment is performed on the surface of the liquid crystal layer including the disk-like liquid crystal compound such that the surface is hydrophilic. In a case where the layer including the rod-like liquid crystal compound is formed in a state where the surface of the liquid crystal layer including the disk-like liquid crystal compound is hydrophilic, the rod-like liquid crystal compound is likely to be hydrophobic. Therefore, the aligning properties of the rod-like liquid crystal compound may decrease.

### [Virtual Reality Display Device]

The virtual reality display device according to the present invention includes the laminate according to the embodiment of the present invention.

In the virtual reality display device according to the embodiment of the present invention, it is preferable that the laminate according to the embodiment of the present invention is used as a reflective polarizer. In particular, it is preferable that the laminate according to the embodiment of the present invention is used as a reflective polarizer in a virtual reality display device including a reciprocating optical system that reflects light to reciprocate between the reflective polarizer and a half mirror.

The configuration of the reflective optical system and the configuration of the virtual reality display device can be found in JP1996-120679A (JP-H7-120679A), JP2017-227720A, and the like.

### Examples

The present invention will be described in more detail based on the following examples.

Materials, used amounts, ratios, treatment details, treatment procedures, and the like shown in the following Examples can be appropriately changed within a range not departing from the scope of the present invention. Accordingly, the scope of the present invention will not be restrictively interpreted by the following Examples.

### [Manufacturing of Laminate]

Laminates used in Examples and Comparative Examples were manufactured in the following procedure. Specifically, first, a composition including a liquid crystal compound was applied to a substrate, and a predetermined treatment was performed thereon to form a cholesteric liquid crystal layer. A composition including a liquid crystal compound was applied to the formed cholesteric liquid crystal layer, and a predetermined treatment was performed thereon to form a cholesteric liquid crystal layer. As a result, a laminate was obtained.

Hereinafter, each of the compositions and a method of forming the cholesteric liquid crystal layers will be described.

### <Composition>

All of the compositions shown below are compositions for forming the cholesteric liquid crystal layers. A composition with a reference numeral including “R” refers to a composition including a rod-like liquid crystal compound, and a composition with a reference numeral including “D” refers to a composition including a disk-like liquid crystal compound.

### (Composition R-1)

In a container kept at 70° C., the following components were stirred and dissolved to prepare a composition R-1.

Composition R-1

| | | |
|---|---|---|
| Methyl ethyl ketone | 176.9 | parts by mass |
| Cyclohexanone | 44.2 | parts by mass |
| Rod-like liquid crystal compound A1 (mixture) | 50.0 | parts by mass |
| The following rod-like liquid crystal | 50.0 | parts by mass |
| compound A2 | | |
| Photopolymerization initiator B | 1.00 | part by mass |
| Chiral agent A1 | 3.00 | parts by mass |
| Surfactant F1 | 0.06 | parts by mass |

### Rod-Like Liquid Crystal Compound A1 (the Mixing Ratio is a Mass Ratio)

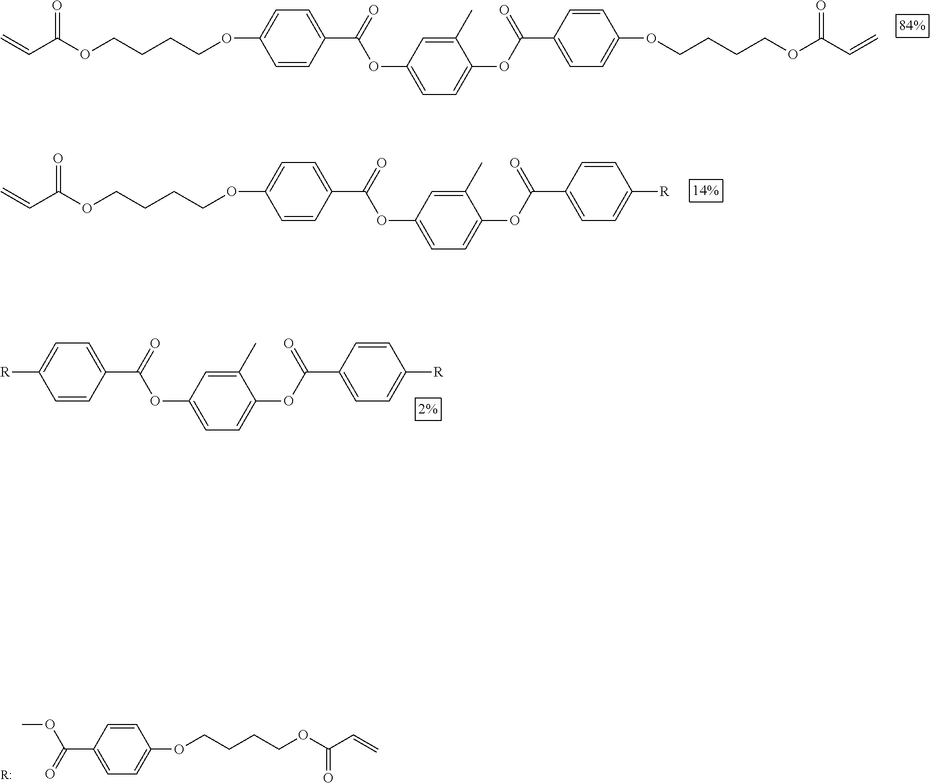

### Rod-Like Liquid Crystal Compound A2

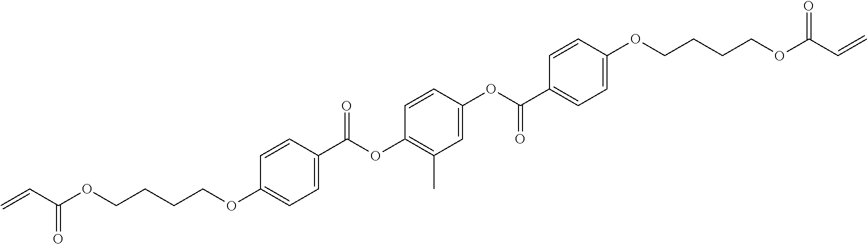 [SMILES: C=CC(=O)OCCCCOc1ccc(C(=O)Oc2ccc(OC(=O)c3ccc(OCCCCOC(=O)C=C)cc3)c(C)c2)cc1]

### Photopolymerization Initiator B

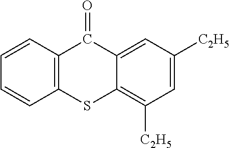 [SMILES: CCc1cc(CC)c2sc3ccccc3c(=O)c2c1]

### Chiral Agent A1

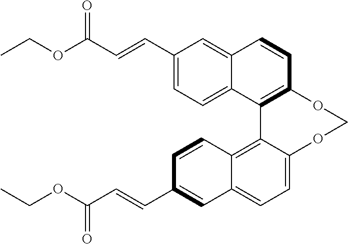

The chiral agent A1 is a chiral agent (chiral agent A) where the helical twisting power (HTP) is reduced by light.

### Surfactant F1 (the Ratio Between the Repeating Units is a Mass Ratio)

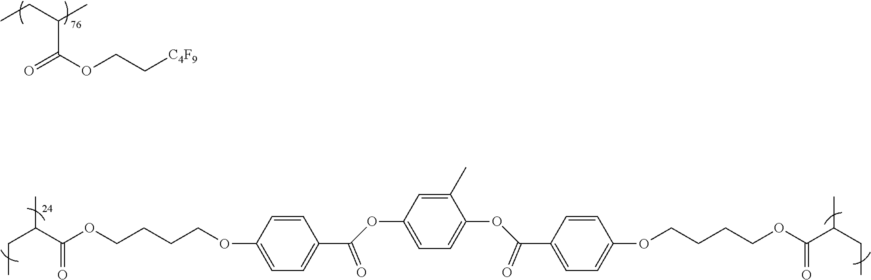

### (Composition R-2)

A composition R-2 was prepared using the same method as that of the composition R-1, except that the addition amount of the chiral agent A1 was changed to 3.63 parts by mass and the addition amount of the surfactant F1 was changed to 0.15 parts by mass.

### (Composition D-1)

In a container kept at 50° C., the following components were stirred and dissolved to prepare a composition D-1.

Composition D-1

| | | |
|---|---|---|
| Disk-like liquid crystal compound (A) | 80 | parts by mass |
| Disk-like liquid crystal compound (B) | 20 | parts by mass |
| Polymerizable monomer E1 | 4 | parts by mass |
| Surfactant F2 | 0.06 | parts by mass |
| Photopolymerization initiator | 3 | parts by mass |
| (IRGACURE 907 manufactured by BASF SE) | | |
| Pyridinium salt (A) | 0.1 | parts by mass |
| Boronic acid monomer A | 3 | parts by mass |
| Chiral agent A1 described above | 4.00 | parts by mass |
| Methyl ethyl ketone | 151 | parts by mass |
| Cyclohexanone | 37 | parts by mass |

### Disk-Like Liquid Crystal Compound (A)

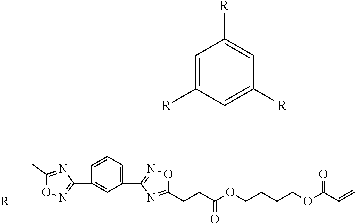

### Disk-Like Liquid Crystal Compound (B)

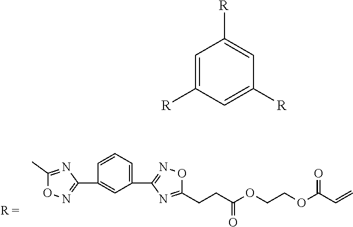

### Polymerizable Monomer E1

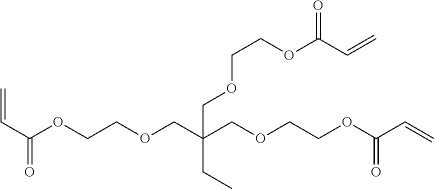 [SMILES: C=CC(=O)OCCOCC(CC)(COCCOC(=O)C=C)COCCOC(=O)C=C]

### Surfactant F2

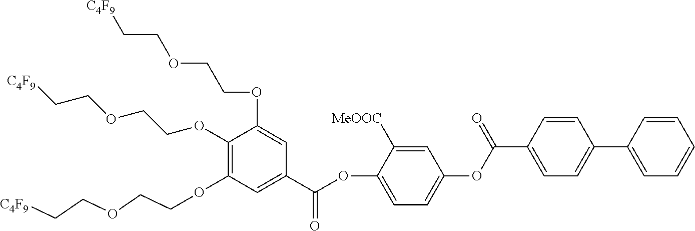

The surfactant F2 was non-liquid-crystalline and had a melting point of 94° C. In addition, the number of aromatic ring structures in the surfactant F2 is 4.

### Pyridinium Salt A

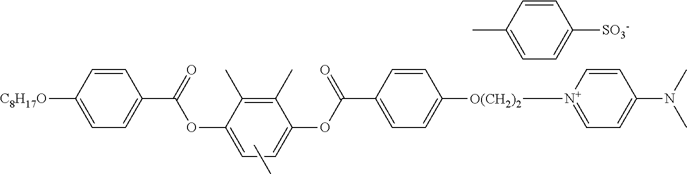

### Boronic Acid Monomer A

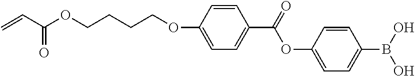 [SMILES: C=CC(=O)OCCCCOc1ccc(C(=O)Oc2ccc(B(O)O)cc2)cc1]

(Composition D-2) A composition D-2 was prepared using the same method as that of the composition D-1, except that the addition amount of the chiral agent A1 was changed to 5.28 parts by mass.

### (Composition D-3)

A composition D-3 was prepared using the same method as that of the composition D-1, except that the surfactant F2 was changed to the following surfactant F3.

### Surfactant F3

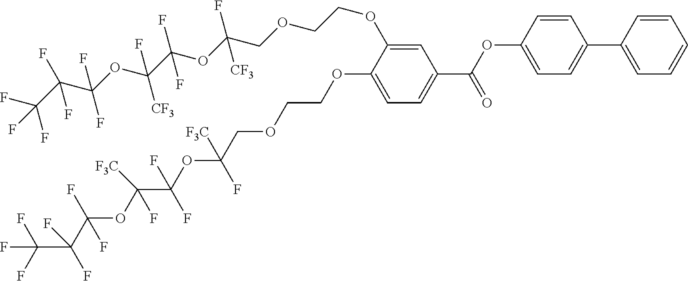 [SMILES: O=C(Oc1ccc(-c2ccccc2)cc1)c1ccc(OCCOCC(F)(OC(F)(F)C(F)(OC(F)(F)C(F)(F)C(F)(F)F)C(F)(F)F)C(F)(F)F)c(OCCOCC(F)(OC(F)(F)C(F)(OC(F)(F)C(F)(F)C(F)(F)F)C(F)(F)F)C(F)(F)F)c1]

The surfactant F3 was non-liquid-crystalline and had a melting point of 50° C. In addition, the number of aromatic ring structures in the surfactant F3 is 3.

### (Composition D-4)

A composition D-3 was prepared using the same method as that of the composition D-2, except that the surfactant F2 was changed to the following surfactant F3.

### Composition D-5

A composition D-5 was prepared using the same method as that of the composition D-1, except that the surfactant F2 was changed to the following surfactant F4.

### Surfactant F4

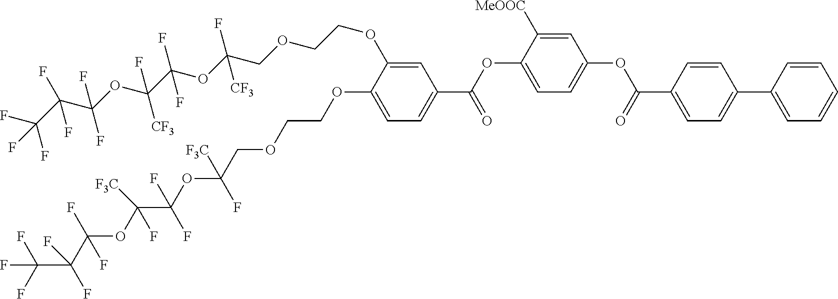 [SMILES: COC(=O)c1cc(OC(=O)c2ccc(-c3ccccc3)cc2)ccc1OC(=O)c1ccc(OCCOCC(F)(OC(F)(F)C(F)(OC(F)(F)C(F)(F)C(F)(F)F)C(F)(F)F)C(F)(F)F)c(OCCOCC(F)(OC(F)(F)C(F)(OC(F)(F)C(F)(F)C(F)(F)F)C(F)(F)F)C(F)(F)F)c1]

The surfactant F4 was non-liquid-crystalline and had a melting point of 108° C.

### (Composition D-6)

A composition D-6 was prepared using the same method as that of the composition D-2, except that the surfactant F2 was changed to the following surfactant F4.

### (Composition D-7)

A composition D-7 was prepared using the same method as that of the composition D-1, except that the addition amount of the chiral agent A1 was changed to 3.1 parts by mass.

### (Composition D-8)

A composition D-8 was prepared using the same method as that of composition D-1, except that a disk-like liquid crystal compound (C) was used instead of the disk-like liquid crystal compounds (A) and (B).

### Disk-Like Liquid Crystal Compound (C)

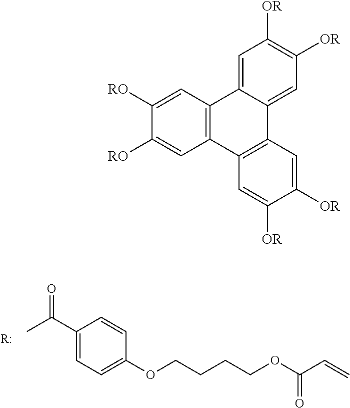

### (Composition D-9)

A composition D-9 was prepared using the same method as that of the composition D-1, except that the addition amount of the chiral agent A1 was changed to 4.1 parts by mass.

### (Composition D-10)

A composition D-8 was prepared using the same method as that of the composition D-1, except that the addition amount of the chiral agent A1 was changed to 4.6 parts by mass.

### <Manufacturing Procedure of Laminate>

Laminates used in Examples and Comparative Examples were obtained in the following procedure.

### (Laminate 1)

A polyethylene terephthalate (PET) film (A4100, manufactured by Toyobo Co., Ltd.) having a thickness of 50 μm was prepared as a temporary support. This PET film includes an easy adhesion layer on one surface.

A surface of the PET film where the easy adhesion layer was not provided was rubbed, the composition R-1 was applied to the surface using a wire bar coater to form a coating film, and the coating film was dried at 110° C. for 120 seconds. Next, the coating film was kept at 80° C., and was irradiated with ultraviolet rays (illuminance: 100 mW/cm², irradiation amount: 250 mJ/cm²) from a metal halide lamp in a nitrogen atmosphere (oxygen concentration: 100 ppm or less) to immobilize an alignment direction of the liquid crystal compound. As a result, a cholesteric liquid crystal layer 1 was formed on the PET film. The irradiation with the ultraviolet rays was performed from the coating film side. In addition, the coating amount of the composition R-1 was adjusted such that the film thickness of the formed cholesteric liquid crystal layer 1 was 4.5 μm.

The cholesteric liquid crystal layer 1 was a cholesteric liquid crystal layer that reflected red light (the central wavelength of reflected light: 650 nm). The cholesteric liquid crystal layer 1 does not correspond to any of the first cholesteric liquid crystal layer and the second cholesteric liquid crystal layer in the present invention.

Next, after performing a corona treatment at a discharge amount of 150 W·min/m² on a surface of the cholesteric liquid crystal layer 1 opposite to the PET film side, and the composition D-1 was applied using a wire bar coater to the surface on which the corona treatment was performed to form a coating film. Next, the coating film was dried at 70° C. for 2 minutes and then was heated and aged at 103° C. for 3 minutes to obtain a uniform alignment state. Next, the coating film was kept at 45° C., and was irradiated with ultraviolet rays (illuminance: 100 mW/cm², irradiation amount: 250 mJ/cm²) from a metal halide lamp in a nitrogen atmosphere (oxygen concentration: 100 ppm or less) to immobilize an alignment direction of the liquid crystal compound. As a result, a cholesteric liquid crystal layer 2 was formed on the cholesteric liquid crystal layer 1. The irradiation with the ultraviolet rays was performed from the coating film side. In addition, the coating amount of the composition D-1 was adjusted such that the film thickness of the formed cholesteric liquid crystal layer 2 was 3.3 μm.

The cholesteric liquid crystal layer 2 was a cholesteric liquid crystal layer that reflected yellow light (the central wavelength of reflected light: 600 nm). The cholesteric liquid crystal layer 2 corresponds to the first cholesteric liquid crystal layer of the present invention.

Next, the composition R-2 was applied to a surface of the cholesteric liquid crystal layer 2 opposite to the PET film side using a wire bar coater to form a coating film, and the coating film was dried at 110° C. for 120 seconds. Next, the coating film was kept at 80° C., and was irradiated with ultraviolet rays (illuminance: 100 mW/cm², irradiation amount: 250 mJ/cm²) from a metal halide lamp in a nitrogen atmosphere (oxygen concentration: 100 ppm or less) to immobilize an alignment direction of the liquid crystal compound. As a result, a cholesteric liquid crystal layer 3 was formed on the cholesteric liquid crystal layer 2. The irradiation with the ultraviolet rays was performed from the coating film side. In addition, the coating amount of the composition R-2 was adjusted such that the film thickness of the formed cholesteric liquid crystal layer 3 was 2.7 μm.

The cholesteric liquid crystal layer 3 was a cholesteric liquid crystal layer that reflected green light (the central wavelength of reflected light: 550 nm). The cholesteric liquid crystal layer 3 corresponds to the second cholesteric liquid crystal layer of the present invention.

Next, after performing a corona treatment at a discharge amount of 150 W·min/m² on a surface of the cholesteric liquid crystal layer 3 opposite to the PET film side, and the composition D-2 was applied using a wire bar coater to the surface on which the corona treatment was performed to form a coating film. Next, the coating film was dried at 70° C. for 2 minutes and then was heated and aged at 100° C. for 3 minutes to obtain a uniform alignment state. Next, the coating film was kept at 45° C., and was irradiated with ultraviolet rays (illuminance: 100 mW/cm², irradiation amount: 250 mJ/cm²) from a metal halide lamp in a nitrogen atmosphere (oxygen concentration: 100 ppm or less) to immobilize an alignment direction of the liquid crystal compound. As a result, a cholesteric liquid crystal layer 4 was formed on the cholesteric liquid crystal layer 3. The irradiation with the ultraviolet rays was performed from the coating film side. In addition, the coating amount of the composition D-2 was adjusted such that the film thickness of the formed cholesteric liquid crystal layer 4 was 2.5 μm.

The cholesteric liquid crystal layer 4 was a cholesteric liquid crystal layer that reflected blue light (the central wavelength of reflected light: 460 nm). The cholesteric liquid crystal layer 4 does not correspond to any of the first cholesteric liquid crystal layer and the second cholesteric liquid crystal layer in the present invention.

A laminate 1 was obtained in the above-described procedure.

### (Laminate 2)

A laminate 2 was obtained in the same procedure as that of the laminate 1, except that the composition D-3 was used instead of the composition D-1 and the composition D-4 was used instead of the composition D-2.

### (Laminate 3)

A laminate 3 was obtained in the same procedure as that of the laminate 1, except that the composition D-7 was used instead of the composition R-1, the composition D-8 was used instead of the composition D-1, the composition D-9 was used instead of the composition R-2, and the composition D-10 was used instead of the composition D-2.

In a case where the layers were laminated, the composition D-1 was applied, and the conditions for the formation of the cholesteric liquid crystal layer 2 were applied. That is, a corona treatment was performed before applying each of the compositions.

### (Laminate 4)

A laminate 4 was obtained in the same procedure as that of the laminate 1, except that the composition D-5 was used instead of the composition D-1 and the composition D-6 was used instead of the composition D-2.

### [Measurement]

### <Measurement of Aggregates>

Regarding samples in a state where the cholesteric liquid crystal layer 3 was prepared in the laminates 1 to 3, in the above-described procedure, a surface of the cholesteric liquid crystal layer 3 opposite to the cholesteric liquid crystal layer 2 was analyzed by TOF-SIMS, and secondary ions derived from the surfactant were mapped to count the number of aggregates derived from the surfactant.

### <Measurement of Dark Line Region Width/Dark Line Width Ratio>

In the above-described procedure, the dark line region width/dark line width ratios of the laminates 1 to 4 were obtained.

For the observation, “S-4800” (manufactured by Hitachi High-Tech Corporation) was used. In the observation with the SEM, an acceleration voltage was set to 2 kV, and a secondary electron image was acquired at a magnification of 20000-fold.

The value of the ratio (region width Wrb/width Wb) of the region width Wrb to the width Wb was 1.0 in all of the laminates.

### <Transfer of Surfactant>

The degree of transfer of the substrate from the cholesteric liquid crystal layer 2 to the substrate was evaluated by X-ray photoelectron spectroscopy using the above-described method.

In the table of the latter stage, the results are shown based on the following standards.
A: the content of fluorine atoms was less than 2% by atom with respect to all the atoms
B: the content of fluorine atoms was 2% by atom or more and less than 5% by atom with respect to all the atoms
C: the content of fluorine atoms was 5% by atom or more with respect to all the atoms

### [Evaluation]

### <Reflectivity>

Reflectivities of the laminates 1 to 4 were measured using a spectrophotometer (V-550, manufactured by JASCO Corporation). Regarding the reflectivity, the reflectivity at the central wavelength of the reflected light of each of the cholesteric liquid crystal layers 1 to 4 was measured.

### <Evaluation of Image Sharpness>

In Example 1, a lens of a virtual reality display device “Huawei VR Glass” (manufactured by Huawei Technologies Co., Ltd.), which was a virtual reality display device adopting reciprocating optical system was disassembled, and the lens closest to the viewing side was taken out. The lens was a plano-convex lens having a convex surface on the viewing side, and a reflective circular polarizer was bonded to the plane side. The reflective circular polarizer was peeled off from this lens, and a laminated optical sheet 1 shown in a preparation method of the latter stage was bonded to the plane side such that the side of an absorptive polarizer was the viewing side. The lens to which the laminated optical sheet 1 was bonded was incorporated into the main body again to prepare a virtual reality display device.

Likewise, virtual reality display devices used in Examples 2 and 3 Comparative Example 1 were prepared.

In the prepared virtual reality display devices according to Examples 1 to 3 and Comparative Example 1, a black-and-white checkered pattern was displayed on an image display device, and the degree of image sharpness was evaluated by visual inspection based on the following standards. In a case where the image sharpness was poor, a part or the entirety of the checkered pattern appeared distorted.
A: the distortion of the checkered pattern was not substantially recognized
B: the distortion of the checkered pattern was slightly recognized, but was not noticeable
C: the distortion of the checkered pattern was clearly recognized

### (Preparation of Laminated Optical Sheet)

Laminated optical sheets 1 to 4 were prepared including the laminates 1 to 4.

Representatively, the preparation procedure of the laminated optical sheet 1 including the laminate 1 is shown. The laminated optical sheets 2 to 4 including the laminates 2 to 4 were prepared in the same procedure as the following procedure. The laminated optical sheets 1 to 3 were used in Examples 1 to 3, respectively, and the laminated optical sheet 4 was used in Comparative Example 1.

First, an ultraviolet curable adhesive “ARONIX UVX-6282 (manufactured by Toagosei Co., Ltd.) was applied to an antireflection film “AR200-TO0810-JD” (manufactured by Dexerials Corporation). Next, the laminate 1 and the antireflection film were bonded to each other such that the cholesteric liquid crystal layer 4 of the laminate 1 and the applied adhesive layer faced each other. In the bonded state, the laminate was irradiated with ultraviolet rays (300 mJ/cm²) to cure the adhesive. After curing the adhesive, the PET film of the laminate 1 was peeled off and removed to obtain a laminated sheet. The laminated sheet includes the antireflection film, the adhesive layer, the cholesteric liquid crystal layer 4, the cholesteric liquid crystal layer 3, the cholesteric liquid crystal layer 2, and the cholesteric liquid crystal layer 1 in this order.

The thickness of the cured adhesive layer was 35 μm. In addition, the refractive index of the cured adhesive layer was 1.48.

A λ/4 retardation plate was bonded and adhered to the surface of the laminated sheet on the cholesteric liquid crystal layer 1 side using the adhesive, and the absorptive polarizer was bonded and adhered to the surface of the λ/4 retardation plate opposite to the cholesteric liquid crystal layer 1 side using the adhesive. During the bonding of the absorptive polarizer, the direction was adjusted such that an angle between a slow axis of the λ/4 retardation plate and an absorption axis of the absorptive polarizer was 45°.

The thickness of the cured adhesive layer was 35 μm.

Next, a pressure sensitive adhesive sheet “NCF-D692 (15)” (manufactured by LINTEC Corporation) was bonded to the absorptive polarizer to obtain the laminated optical sheet 1. The laminated optical sheet 1 includes the antireflection film, the adhesive layer, the cholesteric liquid crystal layer 4, the cholesteric liquid crystal layer 3, the cholesteric liquid crystal layer 2, the cholesteric liquid crystal layer 1, the adhesive layer, the λ/4 retardation plate, the adhesive layer, the absorptive polarizer, and the pressure sensitive adhesive sheet in this order. In the obtained laminated optical sheet 1, the number of foreign particles having one side length of 30 μm or more per 1 m² was 90.

The obtained laminated optical sheet 1 was cut in a circular shape having a diameter of 35 mm using a picosecond laser machine. Further, a part of an end part was cut off to express the orientation of the absorption axis of the absorptive polarizer to prepare a notch. During the machining, machining conditions were adjusted such that an angle of the cut end surface with respect to the vertical direction of the laminated optical sheet 1 was 5° or less.

### <Evaluation of Ghosting>

In the virtual reality display devices according to Examples 1 to 3 and Comparative Example 1 prepared for the evaluation of the image sharpness, the black-and-white checkered pattern was displayed on the image display device, and the degree of ghosting was evaluated by visual inspection based on the following standards. In a case where ghosting occurred, double images were recognized, and the contrast of the portion where the double images were recognized decreased.
A: the double images were hardly visible
B: the double images were slightly visible but were not noticeable
C: the double images were clearly visible

### [Result]

Tables 1 shows the configurations of the laminates and the measurement results and the evaluation results of the laminates.

TABLE 1

| | | | | | | Comparative |
|---|---|---|---|---|---|---|
| | | | Example 1 | Example 2 | Example 3 | Example 1 |
| Cholesteric Liquid | Composition | | D-2 | D-4 | D-10 | D-6 |
| Crystal Layer 4 | Liquid Crystal Compound | | Disk-Like | Disk-Like | Disk-Like | Disk-Like |
| | | | Liquid Crystal | Liquid Crystal | Liquid Crystal | Liquid Crystal |
| | | | Compound | Compound | Compound | Compound |
| | | | (A/B) | (A/B) | (A/B) | (A/B) |
| | Surfactant | Kind | F2 | F3 | F2 | F4 |
| | | Melting Point of | 94 | 50 | 94 | 108 |
| | | Surfactant [° C.] | | | | |
| Cholesteric Liquid | Composition | | R-2 | R-2 | D-9 | R-2 |
| Crystal Layer 3 | Liquid Crystal Compound | | Rod-Like Liquid | Rod-Like Liquid | Disk-Like | Rod-Like |
| (Second | | | Crystal Compound | Crystal Compound | Liquid Crystal | Liquid Crystal |
| Cholesteric Liquid | | | (A1/A2) | (A1/A2) | Compound | Compound |
| Crystal Layer) | | | | | (C) | (A1/A2) |
| | Surfactant | Kind | F1 | F1 | F2 | F1 |
| Cholesteric Liquid | Composition | | D-1 | D-3 | D-8 | D-5 |
| Crystal Layer 2 | Liquid Crystal Compound | | Disk-Like | Disk-Like | Disk-Like | Disk-Like |
| (First Cholesteric | | | Liquid Crystal | Liquid Crystal | Liquid Crystal | Liquid Crystal |
| Liquid Crystal | | | Compound | Compound | Compound | Compound |
| Layer) | | | (A/B) | (A/B) | (A/B) | (A/B) |
| | Surfactant | Kind | F2 | F3 | F2 | F4 |
| | | Melting Point of | 94 | 50 | 94 | 108 |
| | | Surfactant [° C.] | | | | |
| Cholesteric Liquid | Composition | | R-1 | R-1 | D-7 | R-1 |
| Crystal Layer 1 | Liquid Crystal Compound | | Rod-Like Liquid | Rod-Like Liquid | Disk-Like | Rod-Like |
| | | | Crystal Compound | Crystal Compound | Liquid Crystal | Liquid Crystal |
| | | | (A1/A2) | (A1/A2) | Compound | Compound |
| | | | | | (C) | (A1/A2) |
| | Surfactant | Kind | F1 | F1 | F2 | F1 |
| Measurement | Aggregates [aggregates/mm²] | | 0 | 0 | 0 | 11000 |
| | Dark Line Region | Cholesteric | 1.0 | 1.0 | 1.0 | 1.3 |
| | Width/Dark Line | Liquid Crystal | | | | |
| | Width Ratio | Layer 3 | | | | |
| | Transfer of Surfactant | | A | C | A | B |
| Evaluation | Reflectivity | Cholesteric | 49 | 47 | 49 | 49 |
| | [%] | Liquid Crystal | | | | |
| | | Layer 4 | | | | |
| | | Cholesteric | 49 | 47 | 49 | 43 |
| | | Liquid Crystal | | | | |
| | | Layer 3 | | | | |
| | | Cholesteric | 49 | 47 | 49 | 49 |
| | | Liquid Crystal | | | | |
| | | Layer 2 | | | | |
| | | Cholesteric | 49 | 47 | 49 | 49 |
| | | Liquid Crystal | | | | |
| | | Layer 1 | | | | |

| | | | | |
|---|---|---|---|---|
| Image Sharpness Evaluation | A | C | A | B |
| Ghosting Evaluation | A | A | B | A |

It was verified from the results of Table 1 that, in the laminates according to Examples, a reflectivity of the cholesteric liquid crystal layers was high. On the other hand, in the laminates according to Comparative Examples where the dark line region width/dark line width ratio was not in the predetermined range and the number of aggregates was a given value or more, the reflectivity of the second cholesteric liquid crystal layer was low.

It was verified from a comparison between Examples 1 and 2 that, in a case where the surfactant (first surfactant) used for the cholesteric liquid crystal layer 2 was non-liquid-crystalline and had a melting point of 90° C. or higher, the reflectivity of the cholesteric liquid crystal layer was higher, and the image sharpness was higher. In addition, it was verified that the degree of transfer of the surfactant (first surfactant) was low.

It was verified from a comparison between Examples 1 and 2 that, in a case where the surfactant (first surfactant) used for the cholesteric liquid crystal layer 2 has four or more aromatic ring structures, the reflectivity of the cholesteric liquid crystal layer was higher, and the image sharpness was higher.

It was verified from a comparison between Examples 1 and 2 that, in a case where the surfactant (first surfactant) used for the cholesteric liquid crystal layer 2 was the surfactant represented by Formula (11), the reflectivity of the cholesteric liquid crystal layer was higher, and the image sharpness was higher.

It was verified from a comparison between Examples 1 and 2 and Example 3 that, in a case where the cholesteric liquid crystal layers 1 and 3 included a rod-like liquid crystal compound and the cholesteric liquid crystal layers 2 and 4 included a disk-like liquid crystal compound, (the first liquid crystal compound was a disk-like liquid crystal compound and the second liquid crystal compound was a rod-like liquid crystal compound), the occurrence of ghosting was not likely to occur.

### EXPLANATION OF REFERENCES

100: laminate
10: first cholesteric liquid crystal layer
12: second cholesteric liquid crystal layer
26: second liquid crystal layer bright line
28: second liquid crystal layer dark line
28a: surface layer dark line
28b: intermediate dark line
M: intermediate position

What is claimed is:

1. A laminate comprising:
a first cholesteric liquid crystal layer that is formed of a first composition including a first liquid crystal compound; and
a second cholesteric liquid crystal layer that is formed on the first cholesteric liquid crystal layer by an application treatment using a second composition including a second liquid crystal compound,
wherein the first liquid crystal compound is a disk-like liquid crystal compound,
the first liquid crystal compound is a compound different from the second liquid crystal compound,
among bright lines and dark lines that are observed in observation of a cross section of the second cholesteric liquid crystal layer with a scanning electron microscope and are derived from a cholesteric liquid crystalline phase of the second cholesteric liquid crystal layer, in a case where a dark line at a farthest position from the first cholesteric liquid crystal layer side is represented by a surface layer dark line and a dark line at a closest position to an intermediate position in a thickness direction of the second cholesteric liquid crystal layer is represented by an intermediate dark line,
a ratio of a region width where the surface layer dark line is present in the thickness direction of the second cholesteric liquid crystal layer to a width of the intermediate dark line in the thickness direction of the second cholesteric liquid crystal layer is 1.2 or less.

2. The laminate according to claim 1,
wherein a ratio of a region width where the intermediate dark line is present in the thickness direction of the second cholesteric liquid crystal layer to the width of the intermediate dark line in the thickness direction of the second cholesteric liquid crystal layer is 3.0 or less.

3. A laminate comprising:
a first cholesteric liquid crystal layer that is formed of a first composition including a first liquid crystal compound; and
a second cholesteric liquid crystal layer that is formed on the first cholesteric liquid crystal layer by an application treatment using a second composition including a second liquid crystal compound,
wherein the first liquid crystal compound is a disk-like liquid crystal compound,
the first liquid crystal compound is different from the second liquid crystal compound,
the second cholesteric liquid crystal layer includes a surfactant, and
the number of aggregates of the surfactant having a major axis diameter of 0.5 μm or more in a surface of the second cholesteric liquid crystal layer opposite to the first cholesteric liquid crystal layer side is less than 10000 aggregates/mm².

4. The laminate according to claim 3,
wherein the surfactant includes a first surfactant and a second surfactant.

5. The laminate according to claim 4,
wherein the first surfactant is a surfactant in the first composition, and
the first surfactant is liquid-crystalline and has a phase transition temperature of 100° C. or higher from a liquid crystal phase to an isotropic liquid phase, or
the first surfactant is non-liquid-crystalline and has a melting point of 90° C. or higher.

6. The laminate according to claim 5,
wherein the first surfactant has four or more aromatic ring structures.

7. The laminate according to claim 5,
wherein a molecular weight of the first surfactant is 5000 or lower.

8. The laminate according to claim 5,
wherein the first surfactant is represented by Formula (11),
$${( {( Rf )}_{p 1} - {A}_{11} )}_{q 1} - {X}_{12} - {( {L}_{13} - {X}_{13} )}_{r 1} - {L}_{14} - {X}_{14} \qquad ( 11 )$$
in Formula (11), Rf represents a linear perfluoroalkyl group,
in Formula (11), p1 represents an integer of 1 to 3,
in Formula (11), A₁₁'s each independently represent a (p1+1)-valent hydrocarbon group, the hydrocarbon group may include one or more kinds of atoms selected from the group consisting of an oxygen atom and a nitrogen atom,
in Formula (11), q1 represents an integer of 2 to 4,
in Formula (11), X₁₂ represents a (q1+1)-valent aromatic ring group, in Formula (11), X₁₃'s each independently represent a divalent aromatic ring group that may include a substituent,
in Formula (11), L₁₃ and L₁₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—, R₁ represents a hydrogen atom or an alkyl group having 1 to 3 carbon atoms, n represents an integer of 1 to 3,
in Formula (11), r1 represents an integer of 0 to 4, in a case where L₁₄ represents —COO—CH₂—, r1 represents 0,
in Formula (11), X₁₄ represents a monovalent aromatic ring group that may be substituted with —CN, —R₂, —OR₂, —OH, —(CH₂)ₘ—OH, —F, or —COOR₂, or represents a group having the following structure, and in the following structure, * represents a bonding position to L₁₄, 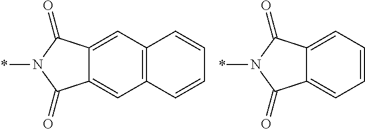
R₂ represents a linear or branched alkyl group having 1 to 20 carbon atoms, and
m represents an integer of 1 to 3.

9. The laminate according to claim 3,
wherein the second liquid crystal compound is a rod-like liquid crystal compound.

10. A virtual reality display device comprising:
the laminate according to claim 1.

11. The laminate according to claim 4,
wherein the first surfactant has four or more aromatic ring structures.

12. The laminate according to claim 4,
wherein a molecular weight of the first surfactant is 5000 or lower.

13. The laminate according to claim 4,
wherein the first surfactant is represented by Formula (11),
$${( {( Rf )}_{p 1} - {A}_{11} )}_{q 1} - {X}_{12} - {( {L}_{13} - {X}_{13} )}_{r 1} - {L}_{14} - {X}_{14} \qquad ( 11 )$$
in Formula (11), Rf represents a linear perfluoroalkyl group,
in Formula (11), p1 represents an integer of 1 to 3,
in Formula (11), A₁₁'s each independently represent a (p1+1)-valent hydrocarbon group, the hydrocarbon group may include one or more kinds of atoms selected from the group consisting of an oxygen atom and a nitrogen atom,
in Formula (11), q1 represents an integer of 2 to 4,
in Formula (11), X₁₂ represents a (q1+1)-valent aromatic ring group, in Formula (11), X₁₃'s each independently represent a divalent aromatic ring group that may include a substituent,
in Formula (11), L₁₃ and L₁₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—, R₁ represents a hydrogen atom or an alkyl group having 1 to 3 carbon atoms, n represents an integer of 1 to 3,
in Formula (11), r1 represents an integer of 0 to 4, in a case where L₁₄ represents —COO—CH₂—, r1 represents 0,
in Formula (11), X₁₄ represents a monovalent aromatic ring group that may be substituted with —CN, —R₂, —OR₂, —OH, —(CH₂)ₘ—OH, —F, or —COOR₂, or represents a group having the following structure, and in the following structure, * represents a bonding position to L₁₄, 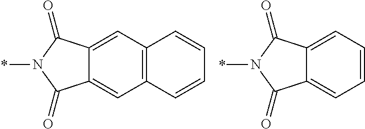
R₂ represents a linear or branched alkyl group having 1 to 20 carbon atoms, and
m represents an integer of 1 to 3.

14. The laminate according to claim 4,
wherein the second liquid crystal compound is a rod-like liquid crystal compound.

15. A virtual reality display device comprising:
the laminate according to claim 2.

16. The laminate according to claim 6,
wherein a molecular weight of the first surfactant is 5000 or lower.

17. The laminate according to claim 6,
wherein the first surfactant is represented by Formula (11),
$${( {( Rf )}_{p 1} - {A}_{11} )}_{q 1} - {X}_{12} - {( {L}_{13} - {X}_{13} )}_{r 1} - {L}_{14} - {X}_{14} \qquad ( 11 )$$
in Formula (11), Rf represents a linear perfluoroalkyl group,
in Formula (11), p1 represents an integer of 1 to 3,
in Formula (11), A₁₁'s each independently represent a (p1+1)-valent hydrocarbon group, the hydrocarbon group may include one or more kinds of atoms selected from the group consisting of an oxygen atom and a nitrogen atom,
in Formula (11), q1 represents an integer of 2 to 4,
in Formula (11), X₁₂ represents a (q1+1)-valent aromatic ring group, in Formula (11), X₁₃'s each independently represent a divalent aromatic ring group that may include a substituent,
in Formula (11), L₁₃ and L₁₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—, R₁ represents a hydrogen atom or an alkyl group having 1 to 3 carbon atoms, n represents an integer of 1 to 3,
in Formula (11), r1 represents an integer of 0 to 4, in a case where L₁₄ represents —COO—CH₂—, r1 represents 0,
in Formula (11), X₁₄ represents a monovalent aromatic ring group that may be substituted with —CN, —R₂, —OR₂, —OH, —(CH₂)ₘ—OH, —F, or —COOR₂, or represents a group having the following structure, and in the following structure, * represents a bonding position to L₁₄, 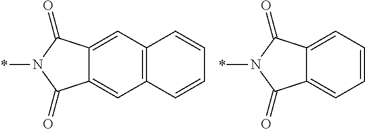
R₂ represents a linear or branched alkyl group having 1 to 20 carbon atoms, and
m represents an integer of 1 to 3.

18. The laminate according to claim 6,
wherein the second liquid crystal compound is a rod-like liquid crystal compound.

19. A virtual reality display device comprising:
the laminate according to claim 3.

20. The laminate according to claim 7,
wherein the first surfactant is represented by Formula (11),
$${( {( Rf )}_{p 1} - {A}_{11} )}_{q 1} - {X}_{12} - {( {L}_{13} - {X}_{13} )}_{r 1} - {L}_{14} - {X}_{14} \qquad ( 11 )$$
in Formula (11), Rf represents a linear perfluoroalkyl group,
in Formula (11), p1 represents an integer of 1 to 3,
in Formula (11), A₁₁'s each independently represent a (p1+1)-valent hydrocarbon group, the hydrocarbon group may include one or more kinds of atoms selected from the group consisting of an oxygen atom and a nitrogen atom,
in Formula (11), q1 represents an integer of 2 to 4,
in Formula (11), X₁₂ represents a (q1+1)-valent aromatic ring group, in Formula (11), X₁₃'s each independently represent a divalent aromatic ring group that may include a substituent,
in Formula (11), L₁₃ and L₁₄ each independently represent a single bond, —CO—, —COO—, —CONR₁—, —O—, —(CH₂)ₙ—, —(CH₂)ₙ—O—, —O—(CH₂)ₙ—, —CO—CH═CH—, —COO—(CH₂)ₙ—, or —C≡C—, R₁ represents a hydrogen atom or an alkyl group having 1 to 3 carbon atoms, n represents an integer of 1 to 3,
in Formula (11), r1 represents an integer of 0 to 4, in a case where L₁₄ represents —COO—CH₂—, r1 represents 0,
in Formula (11), X₁₄ represents a monovalent aromatic ring group that may be substituted with —CN, —R₂, —OR₂, —OH, —(CH₂)ₘ—OH, —F, or —COOR₂, or represents a group having the following structure, and in the following structure, * represents a bonding position to L₁₄, 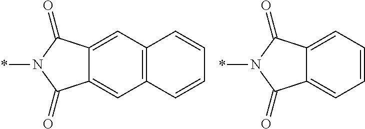
R₂ represents a linear or branched alkyl group having 1 to 20 carbon atoms, and
m represents an integer of 1 to 3.
